(19) United States
(12) Patent Application Publication
(10) Pub. No.: US 2026/0306334 A1
(43) Pub. Date: Oct. 8, 2026

(54) SURGICAL TABLE INCLUDING ADJUSTABLE HEADREST

(71) Applicant: American Sterilizer Company, Mentor, OH (US)

(72) Inventor: Andrew Moss, Solon, OH (US)

(73) Assignee: American Sterilizer Company, Mentor, OH (US)

(21) Appl. No.: 19/482,920

(22) PCT Filed: May 15, 2024
(86) PCT No.: PCT/US2024/029365

§ 371 Date: Nov. 10, 2025

Related U.S. Application Data
(60) Provisional application No. 63/466,774, filed on May 16, 2023.

(51) Int. Cl. A61G 13/12; A61G 13/08

(52) U.S. Cl. CPC A61G 13/121; A61G 13/08

(57) ABSTRACT

An adjustable headrest for surgical table includes an attachment member, frame, head support plate, and lock-unlock actuator having a linearly displaceable bar and a user handle. The linearly displaceable bar is supported and slidably guided for translating movement between a first position and a second position and is spring biased to move from the second position to the first position. In the first position the linearly displaceable bar is configured to lock the frame pivotably against lowering of a distal end of the frame relative to the attachment member and to lock the head support plate pivotably relative to the frame. In the second position the linearly displaceable bar is configured to unlock the frame pivotably relative to the attachment member to allow lowering of the distal end of the frame relative to the attachment member and to unlock the head support plate pivotably relative to the frame.

### CLAIM OF PRIORITY AND CROSS-REFERENCE TO RELATED APPLICATIONS

This application claims priority to U.S. Provisional Patent Application Ser. No. 63/466,774, filed on May 16, 2023, entitled “SURGICAL TABLE INCLUDING ADJUSTABLE HEADREST,” which is incorporated by reference herein in its entirety.

### FIELD OF INVENTION

This application relates generally to a surgical table, and more particularly to a surgical table including an adjustable headrest for adjusting a headrest of the surgical table.

### BACKGROUND

Surgical tables that include adjustable headrests are known in the art. Examples of adjustable headrests may be found, for example, in U.S. Pat. Nos. 5,427,436 and 6,739,006, and U.S. Patent Application Publication No. 2020/0345573. Some of the shortcomings of these current adjustable headrests include a limited amount of rotational travel of the headrest at each joint, actuating elements protruding into the imaging space of the headrest, and/or complexity in the adjustable mechanism components.

Accordingly, there remains a need for further contributions in this area of technology.

### SUMMARY OF INVENTION

The application relates to surgical tables and adjustable headrests thereof that employ components that address one or more of the foregoing problems.

According to one aspect of the invention, an adjustable headrest for a surgical table includes an attachment member configured to be releasably mounted to the surgical table; a frame having a proximal end and a distal end, the proximal end being mounted for pivotable movement relative to the attachment member to raise and lower the distal end relative to the attachment member; a head support plate mounted for pivotable movement relative to the frame to tilt the head support plate relative to the frame; a lock-unlock actuator including a linearly displaceable bar and a user handle, the linearly displaceable bar being supported and slidably guided by the frame for translating movement between a first position and a second position and being spring biased to move from the second position to the first position, the user handle being configured to move the linearly displaceable bar against the spring bias force from the first position to the second position; wherein in the first position the linearly displaceable bar is configured to lock the frame pivotably against lowering of the distal end of the frame relative to the attachment member and to lock the head support plate pivotably relative to the frame, and wherein in the second position the linearly displaceable bar is configured to unlock the frame pivotably relative to the attachment member to allow lowering of the distal end of the frame relative to the attachment member and to unlock the head support plate pivotably relative to the frame.

Embodiments of the invention may include one or more of the following additional features separately or in combination.

In the first position the linearly displaceable bar may be configured to lock the frame and lock the head support plate simultaneously.

In the second position the linearly displaceable bar may be configured to unlock the frame and unlock the head support plate simultaneously.

In the first position the linearly displaceable bar may be configured to lock the frame pivotably against raising of the distal end of the frame relative to the attachment member.

The attachment member may include a primary arc shape gear and the lock-unlock actuator may include a primary mating gear, and in the first position the linearly displaceable bar may be configured to engage the primary mating gear with respect to the primary arc shape gear to lock the frame pivotably against lowering of the distal end of the frame relative to the attachment member.

In the second position the linearly displaceable bar may be configured to disengage the primary mating gear with respect to the primary arc shape gear to unlock the frame pivotably relative to the attachment member to allow lowering of the distal end of the frame relative to the attachment member.

The lock-unlock actuator may include a secondary mating gear and the head support plate may include a secondary arc shape gear, and in the first position the linearly displaceable bar may be configured to engage the secondary mating gear with respect to the secondary arc shape gear to lock the head support plate pivotably relative to the frame.

In the second position the linearly displaceable bar may be configured to disengage the secondary mating gear with respect to the secondary arc shape gear to unlock the head support plate pivotably relative to the frame.

The attachment member may include a primary arc shape gear and the lock-unlock actuator may include a pawl, and the pawl and the primary arc shape gear may form a ratchet and pawl mechanism that allows pivotable movement in one direction while preventing pivotable movement in an opposite direction.

In the first position the linearly displaceable bar may be configured to engage the pawl with respect to the primary arc shape gear to lock the frame pivotably against lowering of the distal end of the frame relative to the attachment member.

In the first position the linearly displaceable bar may be configured not to lock the frame pivotably against raising of the distal end of the frame relative to the attachment member.

In the first position, in response to raising of the distal end of the frame relative to the attachment member, the primary arc shape gear may be configured to move the linearly displaceable bar against the spring bias force of the spring from the first position to an intermediate ratchet release position in which the pawl is retracted from engagement with respect to the primary arc shape gear.

In the second position the linearly displaceable bar may be configured to disengage the pawl with respect to the primary arc shape gear to unlock the frame pivotably relative to the attachment member to allow lowering of the distal end of the frame relative to the attachment member.

The adjustable headrest may further include a locking gas spring having a frame connection end at one end thereof and a plate connection end at an opposite end thereof, the locking gas spring being pivotably mounted at the frame connection end to the frame and pivotably mounted at the plate connection end to the head support plate.

The linearly displaceable bar may include an actuating member and the lock-unlock actuator may include a force transfer member configured to transfer force from the actuating member to the locking gas spring to selectively lock and unlock the locking gas spring.

In the first position the linearly displaceable bar may be configured to reduce the force from the actuating member on the force transfer member to lock the locking gas spring, thereby to lock the head support plate pivotably relative to the frame.

In the second position the linearly displaceable bar may be configured to increase the force from the actuating member on the force transfer member to unlock the locking gas spring, thereby to unlock the head support plate pivotably relative to the frame.

The actuating member may include a cam surface of the linearly displaceable bar and the force transfer member may include a link configured to transfer force from the cam surface to a release pin of the locking gas spring.

The locking gas spring may be pivotably mounted to the frame about a spring-frame connection pivot axis.

The link may be pivotably mounted to the frame connection end of the locking gas spring about a link pivot axis that is perpendicular to the spring-frame connection pivot axis and perpendicular to an actuation axis of the locking gas spring.

The link may include a cam abutting end that abuts the cam surface and a release pin abutting end that abuts the release pin, and a jog portion between the cam abutting end and the release pin abutting end that radially offsets a central axis of the cam abutting end from a central axis of the release pin abutting end.

The actuating member may include a cable connection on the linearly displaceable bar, and the force transfer member may include a link and a cable mechanism coupled to the link, wherein the cable mechanism is configured to transfer force from the cable connection to the link, and the link is configured to transfer force from the link to a release pin of the locking gas spring.

The actuating member may include a piston coupler on the linearly displaceable bar, and the force transfer member may include a hydraulic machine configured to transfer force from the piston coupler to a release pin of the locking gas spring.

The frame may be pivotable relative to the attachment member over a range of 180 degrees including perpendicularly upward relative to horizontal.

The head support plate may be pivotable relative to tilt the head support plate up to 45 degrees relative to the frame.

The head support plate may include a pair of rails depending from an underside of the head support plate, the pair of rails defining therebetween a rectangular imaging volume under the head support plate for slidably receiving an X-ray board, and the linearly displaceable bar may be outside of the pair of rails and outside of the rectangular imaging volume.

The following description and the annexed drawings set forth certain illustrative embodiments of the invention. These embodiments are indicative, however, of but a few of the various ways in which the principles of the invention may be employed. Other objects, advantages and novel features according to aspects of the invention will become apparent from the following detailed description when considered in conjunction with the drawings.

### BRIEF DESCRIPTION OF THE DRAWINGS

The annexed drawings, which are not necessarily to scale, show various aspects of the invention.

FIG. 1 is a schematic side view of a surgical table in accordance with an embodiment of the invention.

FIG. 2 is a top right side perspective view of an adjustable headrest of the FIG. 1 surgical table in accordance with an embodiment of the invention.

FIG. 3 is an enlarged view of a right side of the FIG. 2 adjustable headrest with a frame shown in dash lines to show a lock-unlock actuator in accordance with an embodiment of the invention, the lock-unlock actuator being shown in an unlocked position.

FIG. 4 is an exploded view of the right side of the FIG. 2 adjustable headrest.

FIG. 5 is a bottom left side perspective view of the FIG. 2 adjustable headrest.

FIG. 6 is an enlarged exploded view of a left side of the adjustable headrest shown in FIG. 5 with a left side frame member rotated to show greater detail thereof, and showing components of a pivot connection between the left side frame member and an attachment member.

FIG. 7 is an enlarged exploded view of a right side of the adjustable headrest shown in FIG. 5, showing in greater detail a right side frame member, the lock-unlock actuator, and the attachment member.

FIG. 8 is a top left side exploded perspective view of the FIG. 7 right side of the adjustable headrest shown in FIG. 5, showing components of the lock-unlock actuator, the right side frame member, the attachment member, and the head support plate.

FIG. 9 is an enlarged exploded view of the FIG. 7 right side of the adjustable headrest shown in FIG. 5, showing in greater detail a distal end of the frame.

FIG. 10 is a side cross-section view of the right side of the adjustable headrest shown in FIG. 3, as viewed from the plane 10-10 in FIG. 3, except showing the lock-unlock actuator in a locked position.

FIG. 11 is a perspective view of the adjustable headrest shown in FIG. 10, except showing the lock-unlock actuator in the unlocked position.

FIG. 12 is an enlarged view of a secondary mating gear and a secondary arc shape gear of the adjustable headrest shown in FIG. 10.

FIG. 13 is an enlarged view of a primary mating gear and a primary arc shape gear of the adjustable headrest shown in FIG. 10.

FIG. 14 is a side cross-section view of the right side of the FIG. 3 adjustable headrest as viewed from the plane 14-14 in FIG. 3.

FIG. 15 is an enlarged view of the secondary mating gear and the secondary arc shape gear of the adjustable headrest shown in FIG. 14.

FIG. 16 is an enlarged view of the primary mating gear and the primary arc shape gear of the adjustable headrest shown in FIG. 14.

FIG. 17 is bottom cross-section view of the FIG. 14 right side of the adjustable headrest shown in FIG. 3, as viewed from the plane 17-17 in FIG. 14.

FIG. 18 is an enlarged view of a portion of FIG. 17.

FIG. 19 is an enlarged view similar to FIG. 18, except showing the lock-unlock actuator in the locked position.

FIG. 20 is a side elevation view of the FIG. 2 adjustable headrest showing a proximal end of the frame pivoted 45 degrees relative to the attachment member so that a distal end of the frame is raised relative to the attachment member, and the head support plate pivoted 45 degrees relative to the frame so that the head support plate is tilted relative to the frame.

FIG. 21 is a side elevation view of the FIG. 2 adjustable headrest showing the frame and the head support plate both in a horizontal position.

FIG. 22 is a side elevation view of the FIG. 2 adjustable headrest showing the proximal end of the frame pivoted 90 degrees relative to the attachment member so that the distal end of the frame is lowered relative to the attachment member, and showing the head support plate not tilted relative to the frame.

FIG. 23 shows a lock-unlock actuator in accordance with another embodiment of the invention.

FIG. 24 shows the FIG. 23 lock-unlock actuator in a locked position in which the frame is locked pivotably against lowering of the distal end of the frame relative to the attachment member and the head support plate is locked pivotably relative to the frame.

FIG. 25 shows the FIG. 23 lock-unlock actuator in an intermediate position that is between a locked position and a fully retracted unlocked position, and where the frame is locked pivotably against lowering of the distal end of the frame relative to the attachment member and the head support plate is unlocked pivotably relative to the frame.

FIG. 26 shows the FIG. 23 lock-unlock actuator in a fully retracted unlocked position in which the frame is unlocked pivotably relative to the attachment member to allow lowering of the distal end of the frame relative to the attachment member and the head support plate is unlocked pivotably relative to the frame.

FIG. 27 is a top right side perspective view of an adjustable headrest in accordance with another embodiment of the invention, showing a lock-unlock actuator and a locking gas spring in dash lines.

FIG. 28 is an enlarged view of a right side of the FIG. 27 adjustable headrest with a frame shown in dash lines to show the lock-unlock actuator in greater detail, the lock-unlock actuator being shown in a locked position.

FIG. 29 is a bottom left side perspective view of the FIG. 27 adjustable headrest.

FIG. 30 is an exploded view of the adjustable headrest shown in FIG. 29.

FIG. 31 is a bottom view of FIG. 27 adjustable headrest.

FIG. 32 is a side cross-section view of a right side of the FIG. 27 adjustable headrest as viewed from the plane 32-32 in FIG. 31.

FIG. 33 is a side cross-section view of a right side of the FIG. 27 adjustable headrest as viewed from the plane 33-33 in FIG. 31, the lock-unlock actuator being shown in a locked position.

FIG. 34 is bottom cross-section view of the FIG. 33 right side of the adjustable headrest shown in FIG. 31, as viewed from the plane 34-34 in FIG. 33.

FIG. 35 is bottom cross-section view of the FIG. 33 right side of the adjustable headrest shown in FIG. 31, as viewed from the plane 35-35 in FIG. 33.

FIG. 36 is a bottom right side perspective view of a right side of the FIG. 27 adjustable headrest, except showing the lock-unlock actuator and the locking gas spring in solid lines, and the frame and attachment member in dash lines.

FIG. 37 is the same as the FIG. 33 side cross-section view, except the lock-unlock actuator being shown in an unlocked position.

FIG. 38 is bottom cross-section view of the FIG. 37 right side of the adjustable headrest shown in FIG. 31, as viewed from the plane 38-38 in FIG. 37.

FIG. 39 is an enlarged view of a portion of FIG. 35 where the lock-unlock actuator is shown in the locked position and a force transfer member of the lock-unlock actuator is shown not pivoted.

FIG. 40 is an enlarged view of a portion of FIG. 38 where the lock-unlock actuator is shown in the unlocked position and the force transfer member of the lock-unlock actuator is shown pivoted.

FIG. 41 is a top right side perspective view of the FIG. 27 adjustable headrest with the right side frame shown in dash lines to show the lock-unlock actuator, and where the lock-unlock actuator is shown in a locked position.

FIG. 42 is a side cross-section view of the right side of the adjustable headrest shown in FIG. 41.

FIG. 43 is an enlarged view of a portion of FIG. 33.

FIG. 44 is an enlarged view of a portion of FIG. 42.

FIG. 45 is a side elevation view of the FIG. 27 adjustable headrest showing a proximal end of the frame pivoted 45 degrees relative to the attachment member so that a distal end of the frame is raised relative to the attachment member, and the head support plate pivoted 45 degrees relative to the frame so that the head support plate is tilted relative to the frame.

FIG. 46 is a side elevation view of the FIG. 27 adjustable headrest showing the frame and head support plate both in a horizontal position.

FIG. 47 is a side elevation view of the FIG. 27 adjustable headrest showing the proximal end of the frame pivoted 90 degrees relative to the attachment member so that the distal end of the frame is lower relative to the attachment member, and showing the head support plate not tilted relative to the frame.

FIG. 48 shows a lock-unlock actuator in accordance with another embodiment of the invention.

FIG. 49 shows a lock-unlock actuator in accordance with another embodiment of the invention.

FIG. 50 shows a lock-unlock actuator in accordance with another embodiment of the invention.

### DETAILED DESCRIPTION

While the present invention can take many different forms, for the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications of the described embodiments, and any further applications of the principles of the invention as described herein, are contemplated as would normally occur to one skilled in the art to which the invention relates.

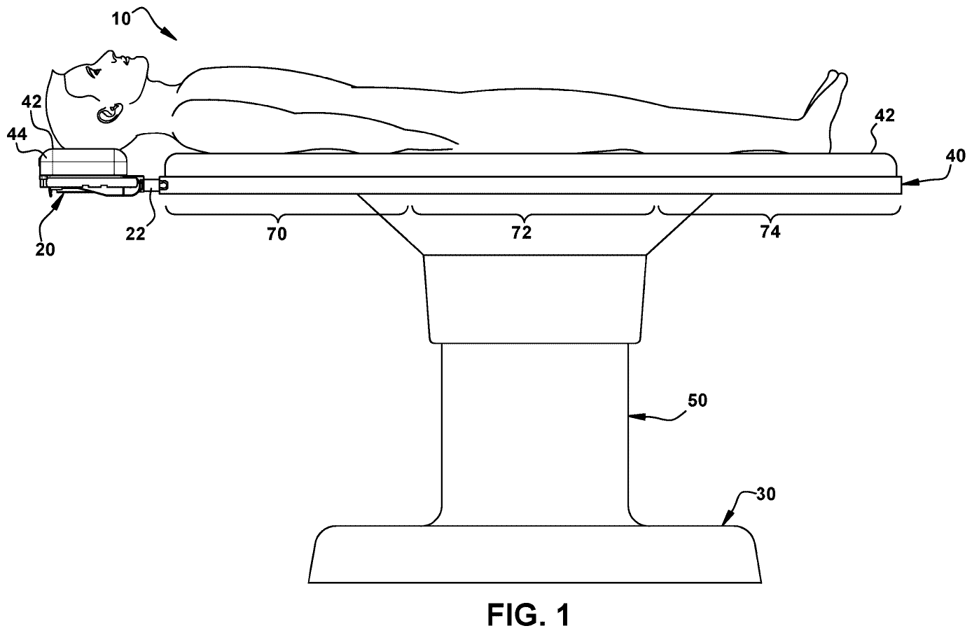

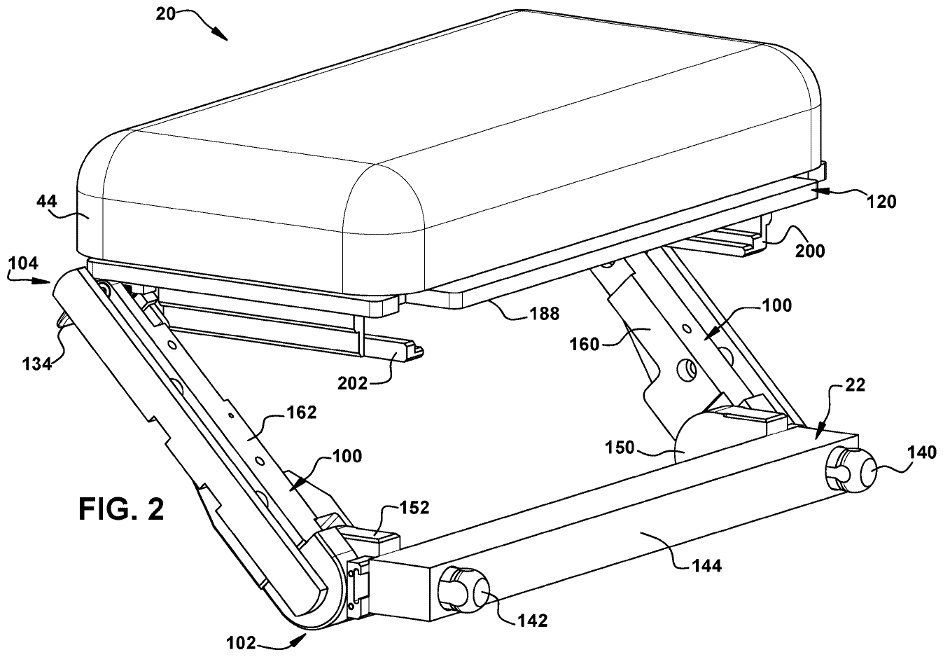

FIGS. 1-22 show a surgical table 10 (FIG. 1) and an adjustable headrest 20 (FIGS. 2-22) thereof in accordance with an embodiment of the invention. The surgical table 10 includes a base 30, a tabletop 40, a column framework 50, and a table framework 60 moveable relative to one another to move the tabletop 40 relative to the base 30. The tabletop 40 provides a patient support surface 42 and includes the adjustable headrest 20 and any number of additional other sections, for example, an upper torso section 70, a lower torso section 72, and a leg section 74. The adjustable headrest 20 includes an attachment member 22, see FIG. 2, configured to be releasably mounted to the upper torso section 70 of the surgical table 10.

As shown in FIGS. 2-7, the adjustable headrest 20 includes a frame 100, a head support plate 120, and a lock-unlock actuator 130 having a linearly displaceable bar 132 and a user handle 134. The frame 100 has a proximal end 102 and a distal end 104. As generally shown in FIGS. 2, 5, and 20-22, the proximal end 102 of the frame 100 is mounted for pivotable movement relative to the attachment member 22 to raise and lower the distal end 104 of the frame 100 relative to the attachment member 22 and the upper torso section 70 to which the attachment member 22 is attached, see FIG. 1. The head support plate 120 is mounted for pivotable movement relative to the frame 100, in the illustrated embodiment the distal end 104 thereof, to tilt the head support plate 120 relative to the frame 100.

The patient support surface 42 of the adjustable headrest 20 may include a cushion 44 that is attached to an upper surface of the head support plate 120.

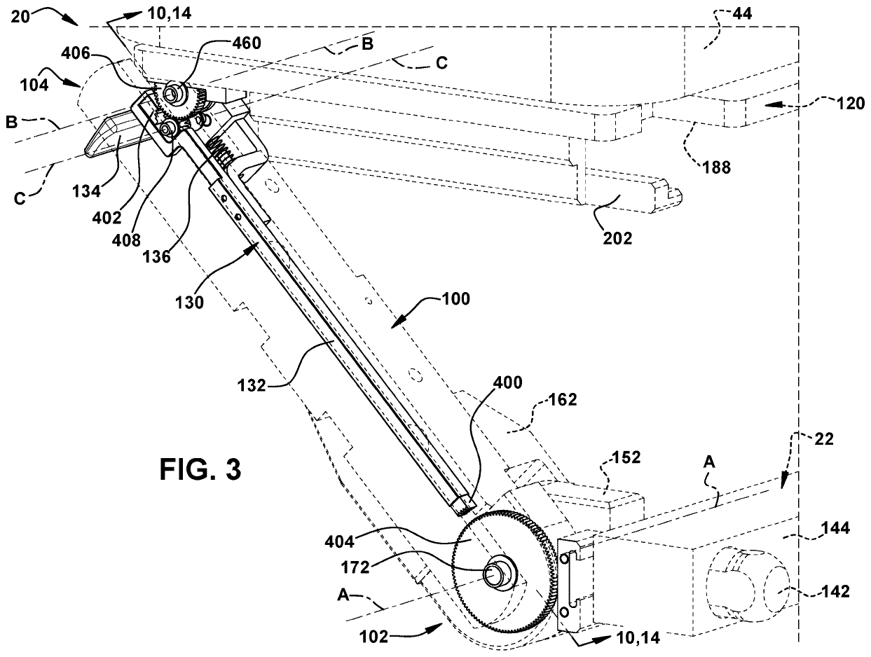

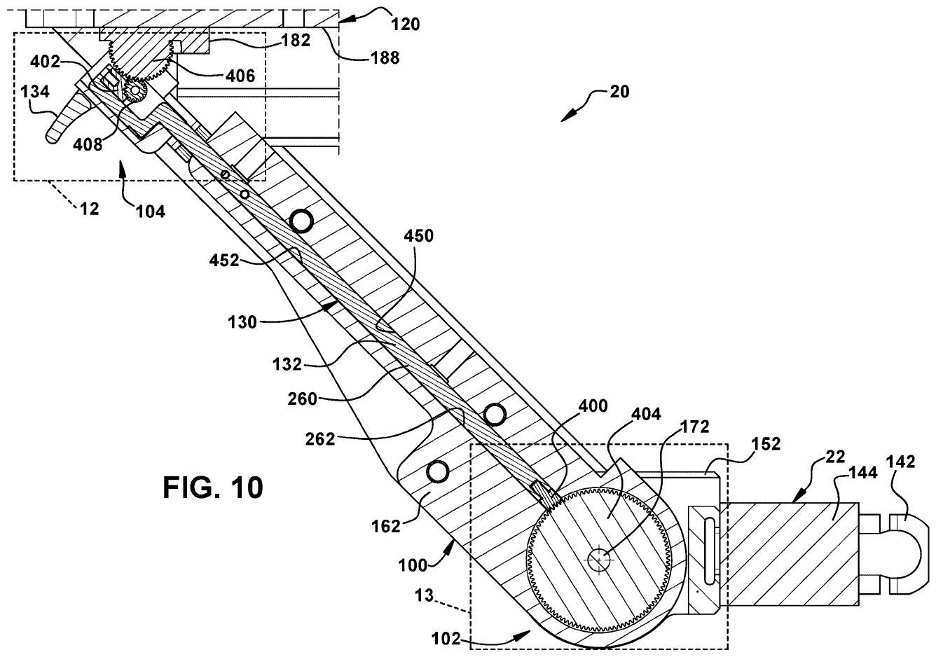

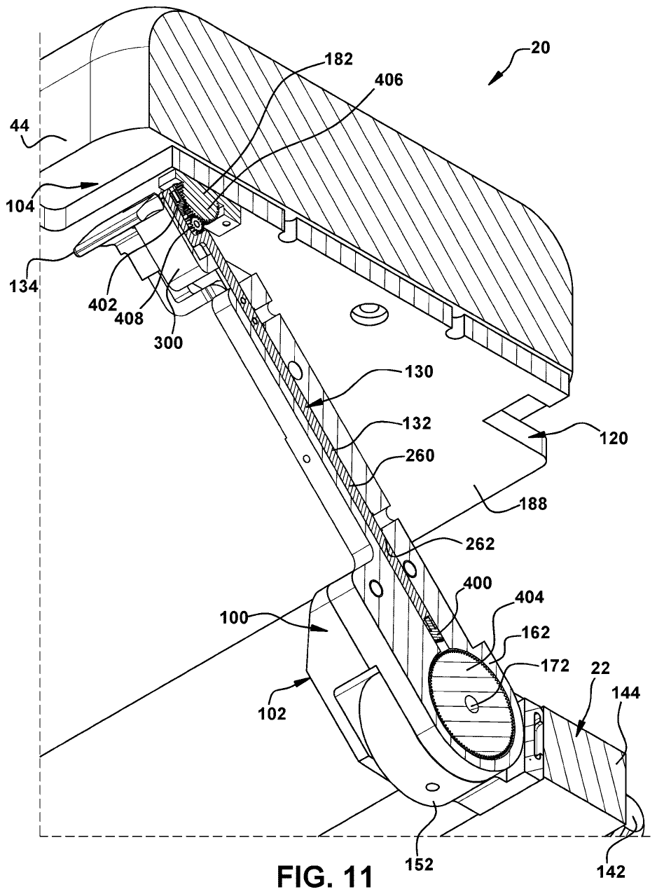

Referring to FIGS. 3-4 and 7-8, the linearly displaceable bar 132 of the lock-unlock actuator 130 is supported and slidably guided by the frame 100 for translating movement. The linearly displaceable bar 132 is translatable between a locked position, shown for example in FIGS. 10 and 12-13, and a unlocked position, shown for example in FIGS. 11 and 14-16. The linearly displaceable bar 132 is spring biased, for example by a spring 136, to move from the unlocked position to the locked position. The user handle 134 of the lock-unlock actuator 130 is configured to move the linearly displaceable bar 132 against the spring bias force of the spring 136 from the locked position to the unlocked position. In the locked position the linearly displaceable bar 132 is configured to lock the frame 100 pivotably against lowering of the distal end 104 of the frame 100 relative to the attachment member 22 and to lock the head support plate 120 pivotably relative to the frame 100. Further, in the unlocked position the linearly displaceable bar 132 is configured to unlock the frame 100 pivotably relative to the attachment member 22 to allow lowering of the distal end 104 of the frame 100 relative to the attachment member 22 and to unlock the head support plate 120 pivotably relative to the frame 100.

As will be described in greater detail below, several advantages may be realized by the components of the adjustable headrest 20 in accordance with the invention. For example, a user can use the user handle 134 to pull the linearly displaceable bar 132 to release both the frame 100 relative to the tabletop 40 and the head support plate 120 relative to the frame 100, so that either of the frame 100 and/or the head support plate 120 can be pivotably adjusted to a desired angular position. The operator can then release the user handle 134 whereby the spring bias force of the spring 136 returns the linearly displaceable bar 132 to the locked position to pivotably lock the frame 100 and head support plate 120 in place. Thus, only one operator input point, that is the user handle 134, is required to lock/unlock two rotational freedoms, that is, the pivot connection between the frame 100 and the surgical table 10, and the pivot connection between the head support plate 120 and the frame 100.

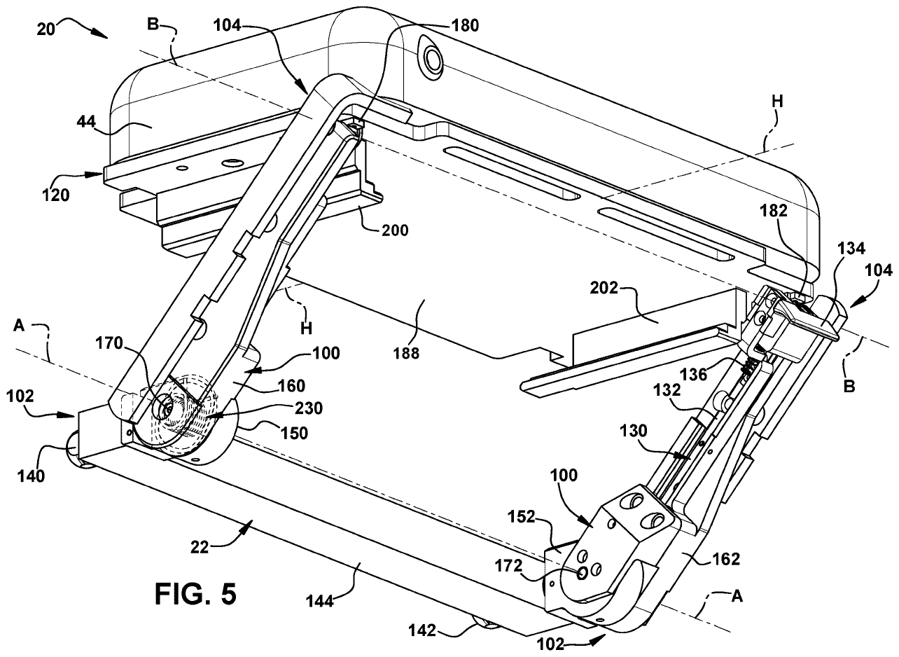

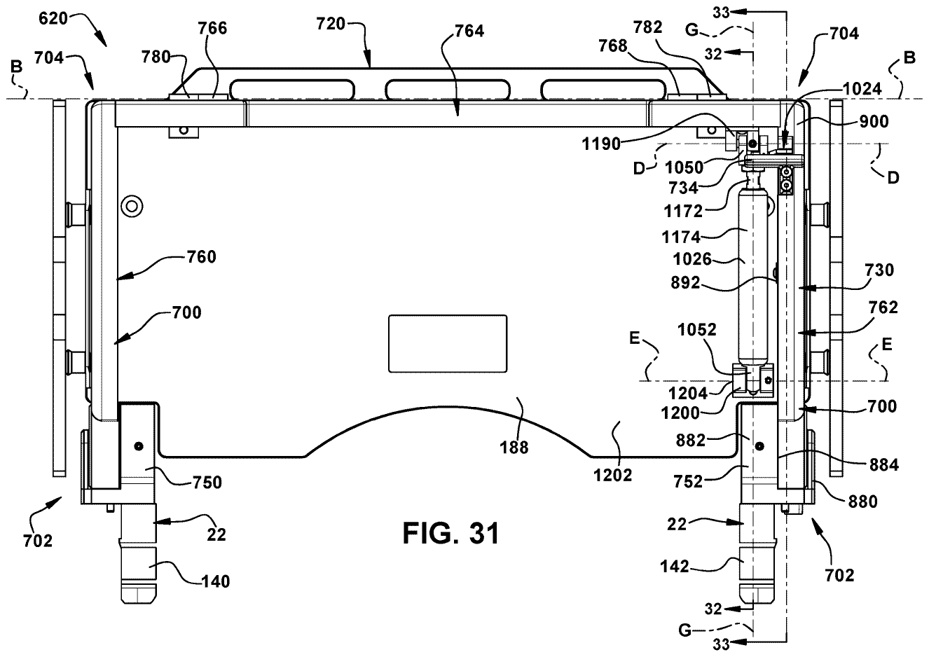

As used herein, horizontal means the plane of the horizon or left to right or right to left across the page in FIG. 1, and vertical means at a right angle, or perpendicular, to the horizontal or horizon, or vertically bottom to top or top to bottom of the page in FIG. 1. Further, as used herein, leftward means in a direction from a right side of the adjustable headrest 20 to a left side of the adjustable headrest 20, for example, from the right side of FIG. 5 (or FIG. 31) to the left side of FIG. 5 (or FIG. 31). Further, as used herein, rightward means in a direction from a left side of the adjustable headrest 20 to a right side of the adjustable headrest 20, for example, from the left side of FIG. 5 (or FIG. 31) to the right side of FIG. 5 (or FIG. 31).

Turning initially then to FIGS. 1 and 2, the attachment member 22 of the adjustable headrest 20 includes left and right shafts 140, 142 and a cross beam 144 extending therebetween and fixed relative to the left and right shafts 140, 142. The left and right shafts 140, 142 are configured to be inserted into mating receptacles (not shown) at an attachment location of the surgical table 10, which in the illustrated embodiment is the upper torso support 70. Inserting the shafts 140, 142 into the receptacles attaches the attachment member 22 and thus the adjustable headrest 20 to the surgical table 10.

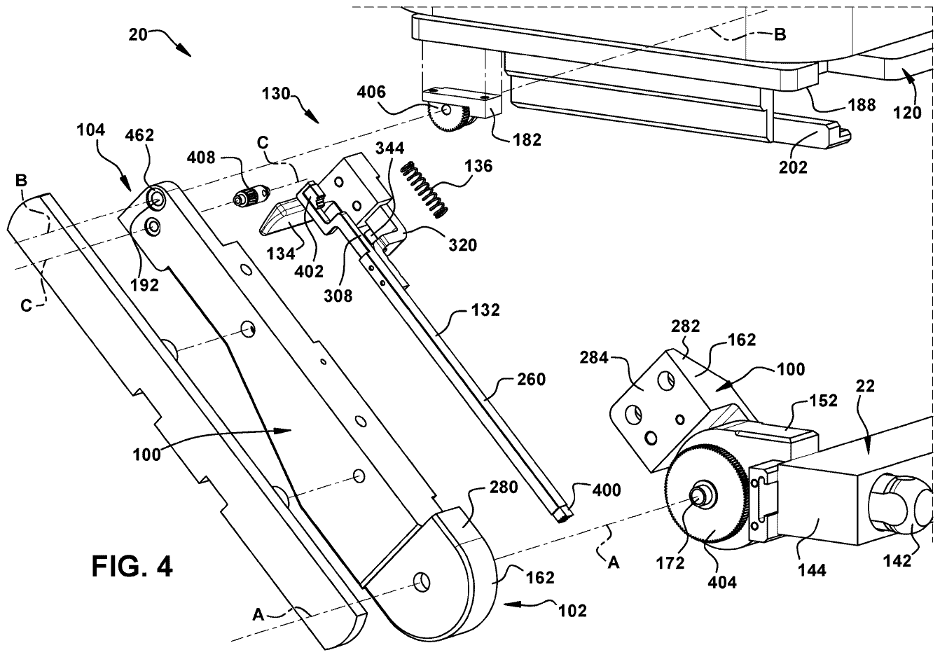

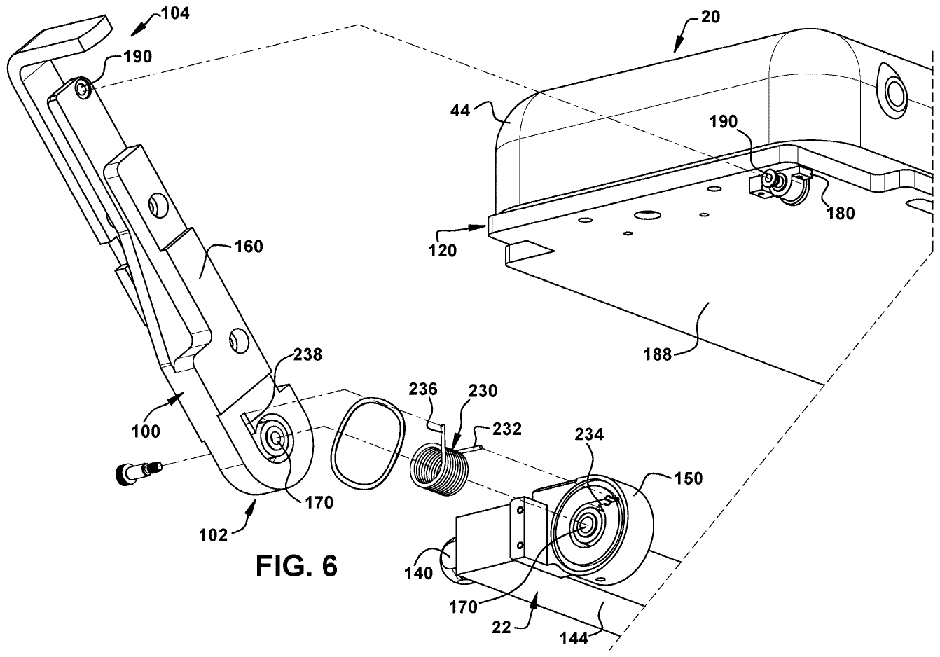

Referring to FIGS. 3-7, the attachment member 22 includes left and right lugs 150, 152 protruding from the cross beam 144 in a direction opposite the respective left and right shafts 140, 142. The frame 100 of the adjustable headrest 20 includes left and right side frame members 160, 162 that are pivotably mounted to the respective left and right lugs 150, 152 via respective pivot joints 170, 172 that share a common pivot axis A-A. The pivot joints 170, 172 enable the left and right side frame members 160, 162 and thus the frame 100 to pivot relative to the attachment member 22 about the pivot axis A-A. As shown in FIGS. 4 and 6, the head support plate 120 includes left and right lugs 180, 182 attached to an underside 188 of the head support plate 120. The left and right lugs 180, 182 are pivotably mounted to the distal ends 104 of the respective left and right side frame members 160, 162 via respective pivot joints 190, 192 that share a common pivot axis B-B, the pivot axis B-B being parallel to the pivot axis A-A. The pivot joints 190, 192 enable the left and right lugs 180, 182 and thus the head support plate 120 to pivot relative to the frame 100 about the pivot axis B-B.

The left and right lugs 150, 152 of the attachment member 22 maintain the axial spacing between the proximal ends 102 of the left and right side frame members 160, 162 as the frame 100 is pivoted about the pivot axis A-A. The head support plate 120 via the connection of the left and right lugs 180, 182 thereof to the respective left and right side frame members 160, 162, maintains the axial spacing between the distal ends 104 of the left and right side frame members 160, 162 as the head support plate 120 is pivoted about the pivot axis B-B. In this way, the head support plate 120 functions as a distal end cross beam of the frame 100, and with reference to FIGS. 2 and 5, a four bar picture frame is formed by the attachment member 22, the left and right side frame members 160, 162, and the head support plate 120. As will be appreciated, the frame 100 itself may include a distal end cross beam extending between and fixedly attached to the left and right side frame members 160, 162, and the head support plate 120 may be pivotably mounted to such distal end cross beam anywhere between the left and right side frame members 160, 162.

With continued reference to FIGS. 2 and 5, the head support plate 120 includes a pair of rails 200, 202 depending from the underside 188 of the head support plate 120 at respective left and right side portions of the head support plate 120. The pair of rails 200, 202 define therebetween a rectangular imaging volume under the head support plate 120 for slidably receiving an X-ray board or the like. As shown in FIG. 5, the pair of rails 200, 202 are L-shape with their respective bottom leg portions facing toward the centerline H-H of the head support plate 120 to support an X-ray board. The axial distance, or left-to-right distance, between the left and right rails 200, 202 is such that the rails 200, 202 can fit within the space provided between the left and right side frame members 160, 162 when the head support plate 120 and the frame 100 are positioned adjacent one another, that is, when the head support plate 120 is not tilted relative to the frame 100, as shown in FIGS. 21 and 22, for example.

As shown in FIGS. 5 and 6, the left side frame member 160 and the left lug 150 of the attachment member 22 house a torsion spring 230. One end 232 of the torsion spring 230 is retained in a recess 234 in the left lug 150 of the attachment member 22 and an opposite end 236 of the torsion spring 230 is retained in a recess 238 in the proximal end 102 of the left side frame member 160. The torsion spring 230 biases the left side frame member 160, and by connection the head support plate 120 and the right side frame member 162, in a direction to raise the distal end 104 of the frame 100 relative to the attachment member 22. In this way, the torsion spring 230 aids in supporting the load on the head support plate 120 and the frame 100 and thus provides positioning assistance to the operator as the operator adjusts the adjustable headrest 20. The torsion spring 230 also reduces the contact pressure on the components of the lock-unlock actuator 130 so that adjustments of the adjustable headrest 20 by the operator are smoother. As will be appreciated, the torsion spring 230 may alternately be provided in the right side frame member 162, or torsion springs 230 may be provided in both the left and right side frame members 160, 162.

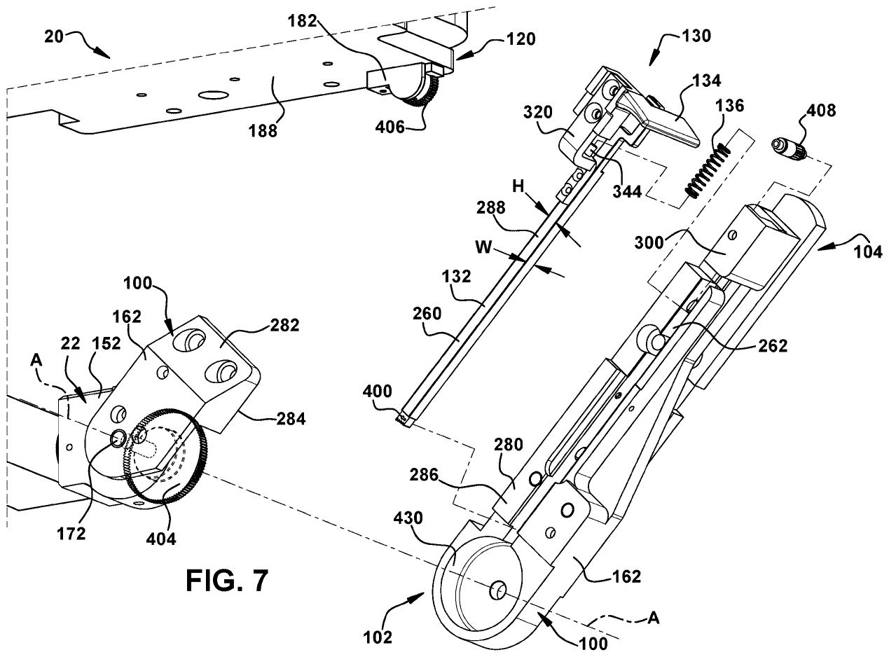

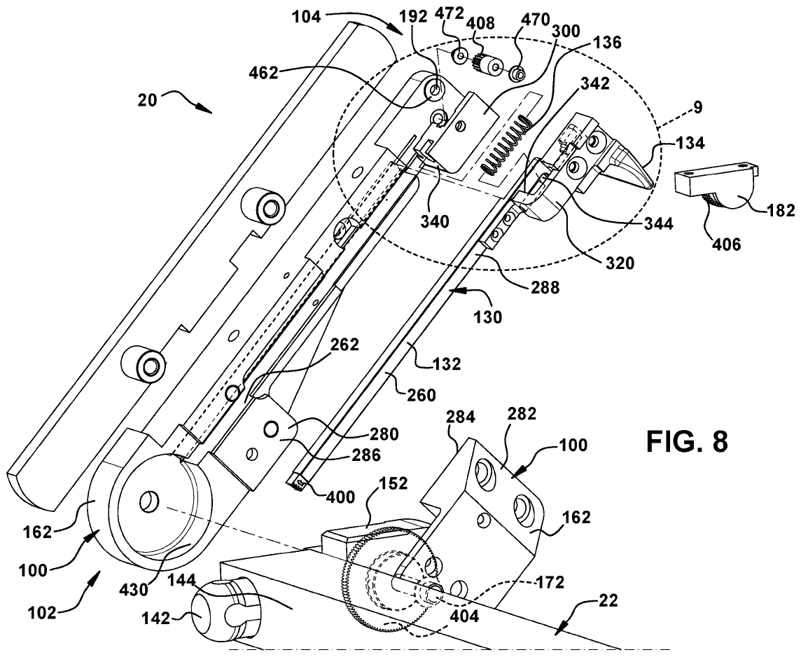

With reference to FIGS. 4 and 7-9 the lock-unlock actuator 130 will now be described in greater detail. As shown in FIGS. 7-9, the linearly displaceable bar 132 of the lock-unlock actuator 130 includes an intermediate elongated member 260 that is positioned within a channel 262 of the right side frame member 162. The channel 262 is sized to support and slidably guide the intermediate elongated member 260 for linear translation movement. In the illustrated embodiment, the intermediate elongated member 260 has a rectangular cross section and the channel 262 likewise has a rectangular cross section. The height of the channel 262 is slightly greater than the height H of the intermediate elongated member 260, see FIG. 7, to retain the intermediate elongated member 260 vertically within the channel 262 while permitting translating movement of the intermediate elongated member 260 within the channel 262. The width of the channel 262 is slightly greater than the width W of the intermediate elongated member 260. The channel 262 includes a leftward facing side 264, see FIGS. 8, 9 and 17-19, to retain the rightward facing side of the intermediate elongated member 260 laterally within the channel 262 while permitting translating movement of the intermediate elongated member 260 within the channel 262.

At the proximal end 102 of the right side frame member 162, the right side frame member 162 is in the form of a clevis having first and second clevis arms 280, 282. As shown in FIGS. 7 and 8, the channel 262 is in the first clevis arm 280. A rightward facing side 284 of the second clevis arm 282 is mounted to a leftward facing side 286 of the first clevis arm 280, for example by not shown fasteners. In this way, the second clevis arm 282 retains a leftward facing side 288 of the intermediate elongated member 260 laterally within the channel 262 at the proximal end 102 of the right side frame member 162 while permitting translating movement of the intermediate elongated member 260 within the channel 262. The clevis formed by the first and second clevis arms 280, 282 is mounted to the pivot joint 172, which pivotably mounts the right side frame member 162 to the attachment member 22 as described above.

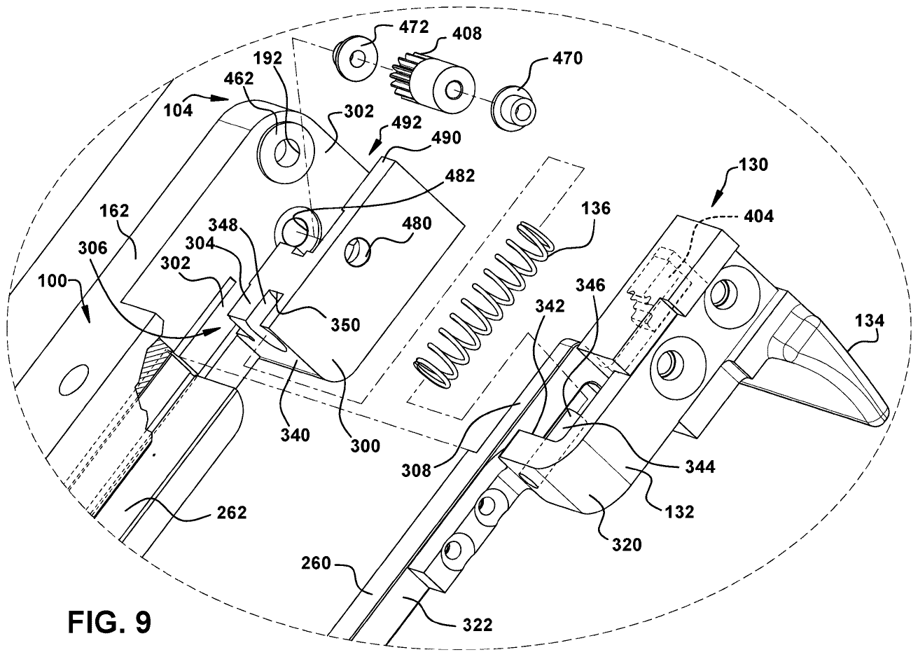

The distal end 104 of the right side frame member 162 includes a retaining lug 300, which is shown in greater detail in FIG. 9. The retaining lug 300 may be attached to a leftward facing side 302 of the right side frame member 162 or may be formed integrally with the right side frame member 162, for example as a monolithic component. The retaining lug 300 includes an upright wall 304 that is spaced leftward from the leftward facing side 302 of the right side frame member 162 to form a gap or channel 306 therebetween. The channel 306 receives therein a portion 308 of the intermediate elongated member 260. In this way, the leftward facing side 302 of the right side frame member 162 and the upright wall 304 of the channel 306 laterally retain the portion 308 of the intermediate elongated member 260 therein and thus laterally retain the intermediate elongated member 260 within the channel 262 at the distal end 104 of the right side frame member 162 while permitting translating movement of the intermediate elongated member 260 within the channel 262.

The user handle 134 of the lock-unlock actuator 130 is attached to a bracket 320, for example by not shown fasteners, and the bracket 320, in turn, is attached to the leftward facing side 288 of the intermediate elongated member 260, also by not shown fasteners. Alternately, the user handle 134 may be formed integrally with the bracket 320, for example as a monolithic component, and/or the bracket 320 may be formed integrally with the intermediate elongated member 260, for example as a monolithic component. As shown in FIGS. 1 and 5, a portion of the user handle 134 protrudes downward relative to the distal end 104 of the frame 100 in the front right corner of the adjustable headrest 20, providing easy access to the user handle 134 by the operator.

With continued reference to FIGS. 8 and 9, the spring 136 of the lock-unlock actuator 130 is positioned relative to the right side frame member 162 and the linearly displaceable bar 132 to generate a spring bias force on the linearly displaceable bar 132 in a direction from the distal end 104 to the proximal end 102 of the right side frame member 162. In the illustrated embodiment, the spring 136 is a linear compression spring and is sandwiched between an end wall 340 of the retaining lug 300 of the right side frame member 162 and an end wall 342 of the bracket 320 of the linearly displaceable bar 132. The spring 136 is mounted on a rod 344 that projects rearwardly from the end wall 342 and has a distal end 346 that is received in a cavity 348 in the end wall 340 of the retaining lug 300. The rod 344 is configured to move axially within the cavity 348 as the linearly displaceable bar 130 is translated within the channel 262 of the right side frame member 162. The rod 344 allows the spring 136 to compress between the two end walls 340, 342 while also preventing radial or lateral shifting of the spring 136, thereby retaining the spring 136 between the two end walls 340, 342.

As shown in FIGS. 9 and 17-19, the rod 344 may also be configured to function as a stop member to limit the amount the lock-unlock actuator 130 can be pulled to a predetermined distance. The cavity 348 in the retaining lug 300 of the right side frame member 162 includes a bottom or distal end wall 350 against which the rod 344 abuts to limit retraction of the lock-unlock actuator 130. The predetermined distance may be for example the distance at which linearly displaceable bar 132 of the lock-unlock actuator 130 disengages the primary mating gear 400 with respect to the primary arc shape gear 404 and the secondary mating gear 402 with respect to the secondary arc shape gear 406.

As will be described in greater detail below with respect to FIGS. 7-19, the lock-unlock actuator 130 includes a primary mating gear 400 and a secondary mating gear 402 that are configured for selective engagement, respectively, relative to a primary arc shape gear 404 of the attachment member 22 and a secondary arc shape gear 406 of the head support plate 120. In the locked position shown for example in FIGS. 10 and 12-13, the linearly displaceable bar 132 is configured to engage the primary mating gear 400 with respect to the primary arc shape gear 404 to lock the frame 100 pivotably against lowering of the distal end 104 of the frame 100 relative to the attachment member 22, and in the unlocked position shown for example in FIGS. 11 and 14-16, the linearly displaceable bar 132 is configured to disengage the primary mating gear 400 with respect to the primary arc shape gear 404 to unlock the frame 100 pivotably relative to the attachment member 22 to allow lowering of the distal end 104 of the frame 100 relative to the attachment member 22. Further, in the locked position the linearly displaceable bar 132 is configured to engage the secondary mating gear 402 with respect to the secondary arc shape gear 406, in the illustrated embodiment via a pinion gear 408 therebetween, to lock the head support plate 120 pivotably relative to the frame 100, and in the unlocked position the linearly displaceable bar 132 is configured to disengage the secondary mating gear 402 with respect to the secondary arc shape gear 406, for example via the pinion gear 408, to unlock the head support plate 120 pivotably relative to the frame 100.

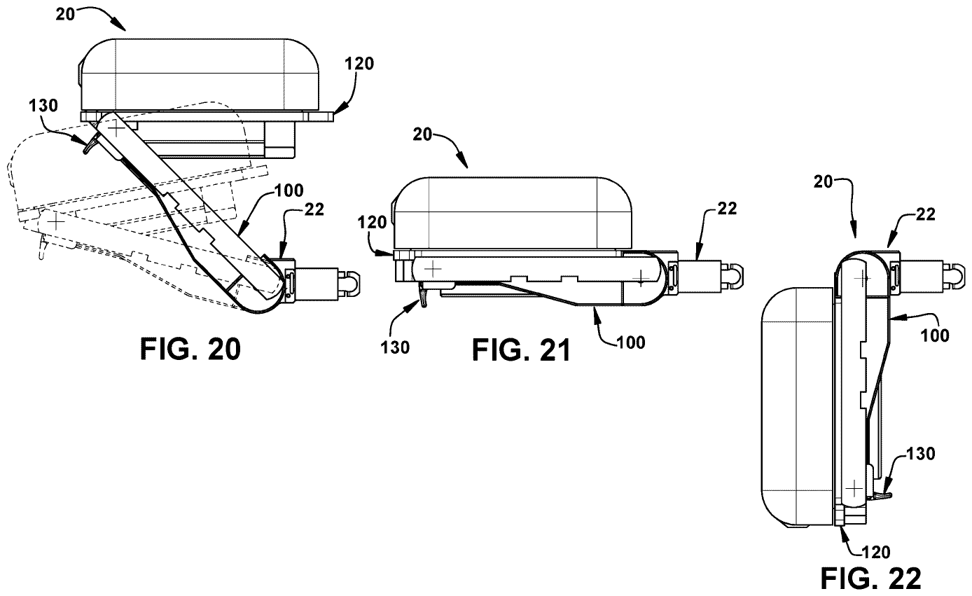

The primary arc shape gear 404 is attached to the right lug 152 of the attachment member 22 for example by not shown fasteners or may be formed integrally with the right lug 152, for example as a monolithic component. In the illustrated embodiment, the primary arc shape gear 404 is circular in shape and is received in a slightly larger diameter circular recess 430 in the proximal end 102 of the right side frame member 162 of the frame 100. The centers of the primary arc shape gear 404 and the circular recess 430 coincide with the afore described pivot axis A-A. As will be appreciated, the primary arc shape gear 404 may be other than circular or 360 degree arc in shape. Other arc shapes are contemplated, for example, a fan shape or sector shape. The amount of arc typically will depend on the desired range of angular positions of the frame 100 relative to the attachment member 22, that is, the desired range of pivot about the pivot axis A-A of the proximal end 102 of the frame 100 relative to the attachment member 22. For example, for the range of pivot in FIGS. 20-22, the primary arc shape gear 404 may be a sector gear of 135 degrees, accounting for the 45 degree pivot in the clockwise direction relative to horizontal in FIG. 20 and the 90 degree pivot in the counterclockwise direction relative to horizontal in FIG. 22.

The primary mating gear 400 is attached to an end of the intermediate elongated member 260 for example as by a threading engagement or may be formed integrally with the intermediate elongated member 260, for example as a monolithic component. As shown in FIGS. 10 and 13, the primary mating gear 400 has a concave arc shape and a gear teeth pattern that are complementary to the convex arc shape and gear teeth pattern of the primary arc shape gear 404 of the attachment member 22. In the illustrated embodiment, the lock-unlock actuator 130 and the frame channel 262 are configured such that when the linearly displaceable bar 132 is translated to the locked position, the primary mating gear 400 protrudes from the channel 262 and into the circular recess 430 for engagement with respect to the primary arc shape gear 404, and such that when the linearly displaceable bar 132 is translated to the unlocked position, the primary mating gear 404 retracts out of the circular recess 262 and back into the channel 262 and thereby out of engagement with respect to the primary arc shape gear 404.

When the primary mating gear 400 is engaged with respect to the primary arc shape gear 404, as shown in FIGS. 10 and 13, the primary arc shape gear 404 in combination with upper and lower surfaces 450, 452 of the channel 262 prevents downward and upward movement of the primary mating gear 400 and the intermediate elongated member 260 to which it is attached, thereby preventing pivotable movement of the proximal end 102 of the right side frame member 162 of the frame 100 about the pivot axis A-A. Thus, for example, referring to FIG. 13, a counterclockwise force on the frame 100 will cause the upper surface 450 of the channel 262 to exert a downward force on the linearly displaceable bar 132 including the primary mating gear 400 thereof, causing the teeth of the primary mating gear 400 to exert a downward force that is opposed by an upward force by the teeth of the primary arc shape gear 404 of the attachment member 22. Conversely, a clockwise force on the frame 100 will cause the lower surface 452 of the channel 262 to exert an upward force on the linearly displaceable bar 132 including the primary mating gear 400 thereof, causing the teeth of the primary mating gear 400 to exert an upward force that is opposed by a downward force by the teeth of the primary arc shape gear 404 of the attachment member 22. In this way, when the linearly displaceable bar 132 is moved to the locked position, as shown in FIGS. 10 and 13, the linearly displaceable bar 132 locks the frame 100 pivotably against both lowering and raising of the distal end 104 of the frame 100 relative to the attachment member 22.

The secondary arc shape gear 406 is formed integrally with the right lug 182 of the head support plate 120 for example as a monolithic component or may be attached to the right lug 182 for example by fasteners. In the illustrated embodiment, the secondary arc shape gear 406 is a sector gear in a fan shape or sector shape and having radii projecting from the pivot axis B-B. An axle 460, see FIG. 3, projects rightward from the secondary arc shape gear 406 and is received in a bearing 462, see FIGS. 4, 8 and 9, of the right side frame member 162 to form the pivot joint 172. The centers of the axle 460, the bearing 462, and the radii of the secondary arc shape gear 406, as well as the center of the corresponding pivot joint 172, coincide with the afore described pivot axis B-B. As will be appreciated, the amount of arc of the secondary arc shape gear 460 may depend on the desired range of pivot about the pivot axis B-B of the head support plate 120 relative to the distal end 104 of the frame 100. For example, although the illustrated secondary arc shape gear 406 is a sector gear of about 180 degrees, for the range of pivot in FIG. 20, the secondary arc shape gear 406 may be a sector gear of only 45 degrees to account for the 45 degree pivot in the clockwise direction in FIG. 20.

The secondary mating gear 402 is attached to the intermediate elongated member 260 at an end that is opposite to the end at which the primary mating gear 400 is attached to the intermediate elongated member 260. The secondary mating gear 402 is attached to the intermediate elongated member 260 for example by not shown fasteners or may be formed integrally with the intermediate elongated member 260, for example as a monolithic component.

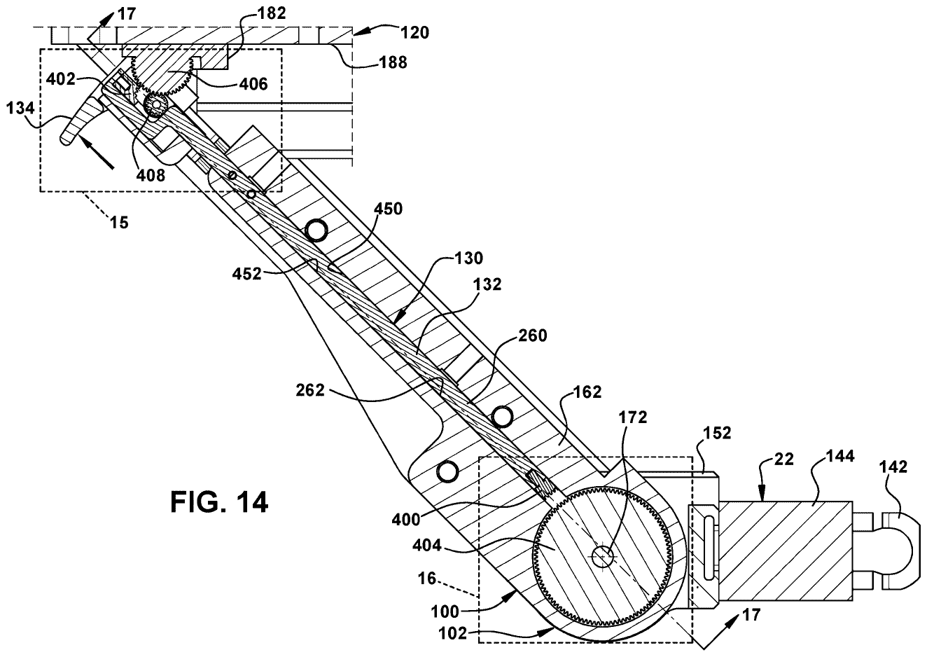

The secondary mating gear 402 is configured to engage and disengage with respect to the secondary arc shape gear 406 of the head support plate 120 via the afore mentioned pinion gear 408. In the illustrated embodiment, the pinion gear 408 is rotationally mounted at its opposite ends to bearings 470, 472 mounted in openings 480, 482 in, respectively, the leftward facing side 302 of the right side frame member 162 and an upright wall 490 of the retaining lug 300 of the right side frame member 162. As shown in FIG. 9, the upright wall 490 is spaced leftward from the leftward facing side 302 of the right side frame member 162 to form a gap or channel 492 therebetween. The pinion gear 408 is on a rotation axis C-C, see FIGS. 3 and 4, that is parallel to and radially offset from the pivot axis B-B of the head support plate 120. The secondary arc shape gear 406 is received within the channel 492 and is in constant engagement with the pinion gear 408. Referring to FIGS. 10 and 14, from a relative standpoint, the pinion gear 408 is configured to revolve about the secondary arc shape gear 406 as the head support plate 120 is pivoted about the pivot axis B-B. Thus, when the pinion gear 408 is free to rotate about the rotation axis C-C, the secondary arc shape gear 406 and thus the head support plate 120 is free to pivot about the pivot axis B-B. Conversely, when the pinion gear 408 is locked from rotation about the rotation axis C-C, the secondary arc shape gear 406 and thus the head support plate 120 is locked from pivoting about the pivot axis B-B.

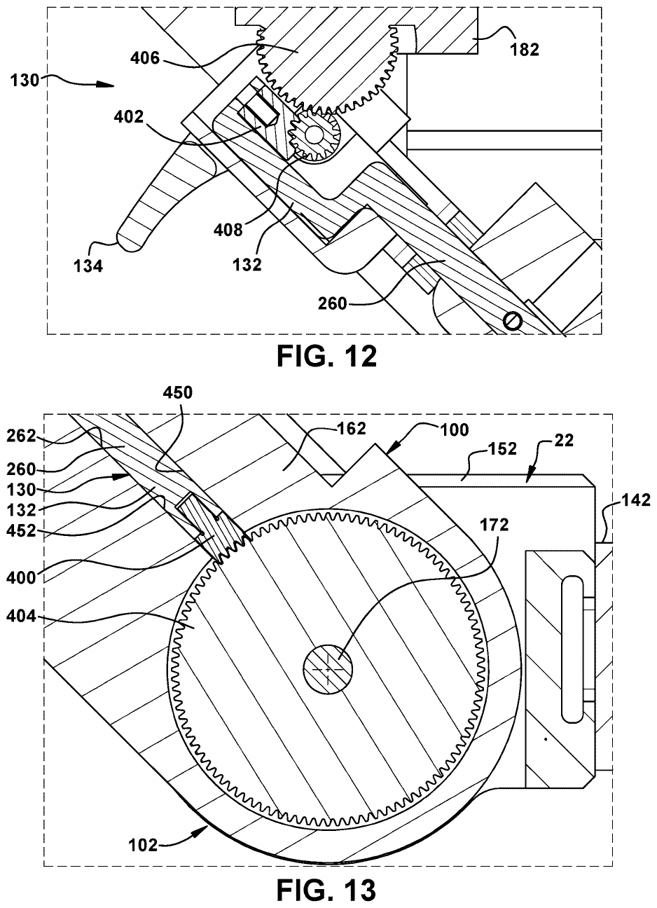

As shown in FIGS. 10 and 12, the secondary mating gear 402 has a concave arc shape and a gear teeth pattern that are complementary to the convex arc shape and gear teeth pattern of the pinion gear 408. In the illustrated embodiment, the lock-unlock actuator 130 and the frame channel 262 are configured such that when the linearly displaceable bar 132 is translated to the locked position, the secondary mating gear 402 engages the pinion gear 408 which, in turn, engages the secondary arc shape gear 406, to lock the gear train of the secondary mating gear 402, the pinion gear 408, and the secondary arc shape gear 406, thus preventing pivotable movement of the head support plate 120 about the pivot axis B-B. When the linearly displaceable bar 132 is translated to the unlocked position, the secondary mating gear 402 retracts out of engagement with the pinion gear 408, thus enabling rotation of the pinion gear 408 about its rotation axis C-C, which enables pivotable movement of the secondary arc shape gear 406 about its pivot axis B-B, and thus enables pivotable movement of the head support plate 120 about the pivot axis B-B.

As will be appreciated, the pinion gear 408 enables a shorter height profile in the adjustable headrest 20. In an alternate embodiment, the pinion gear 408 may be omitted and the secondary mating gear 402 may engage the secondary arc shape gear 406 directly without the intermediate pinion gear 408; in other words, the secondary mating gear 402 and the secondary arc shape gear 406 make up a two-gear gear train. In such case, the secondary arc shape gear 406 may extend vertically downward farther than in the illustrated embodiment and the secondary mating gear 402 may be disposed farther from the pivot axis A-A than the secondary mating gear 402 in the illustrated embodiment. Such a two-gear gear train otherwise functions in the same manner as the illustrated three-gear gear train. Thus, in such alternate embodiment, when the linearly displaceable bar 132 is translated to the locked position, the secondary mating gear 402 engages the secondary arc shape gear 406 directly to lock the two-gear gear train of the secondary mating gear 402 and the secondary arc shape gear 406, and thus prevent pivotable movement of the head support plate 120 about the pivot axis B-B. When the linearly displaceable bar 132 is translated to the unlocked position, the secondary mating gear 402 retracts out of engagement with the pinion gear 408, thus enabling rotation of the pinion gear 408 about its rotation axis C-C, which enables pivotable movement of the secondary arc shape gear 406 about its pivot axis B-B, and thus enables pivotable movement of the head support plate 120 about the pivot axis B-B.

When the secondary mating gear 402 is engaged with respect to the secondary arc shape gear 406 via the pinion gear 408, as shown in FIGS. 10 and 12, the locked gear train of the secondary mating gear 402, the pinion gear 408, and the secondary arc shape gear 406, in combination with the upper and lower surfaces 450, 452 of the channel 262 of the right side frame member 162 of the frame 100, prevents pivotable movement of the secondary arc shape gear 406 and the right lug 182 of which it is a part, thereby preventing pivotable movement of the head support plate 120 about the pivot axis B-B. Thus, for example, referring to FIG. 12, a counterclockwise force on the head support plate 120 will exert a clockwise force on the pinion gear 408, which will exert an upward force on the linearly displaceable bar 132 that is opposed by the upper surface 450 of the channel 262 of the right side frame member 162 of the frame 100. Conversely, a clockwise force on the head support plate 120 will exert a counterclockwise force on the pinion gear 408, which will exert a downward force on the linearly displaceable bar 132 that is opposed by the lower surface 452 of the channel 262 of the right side frame member 162 of the frame 100. In this way, when the linearly displaceable bar 132 is moved to the locked position, as shown in FIGS. 10 and 12, the linearly displaceable bar 132 locks the head support plate 120 pivotably relative to the frame 100.

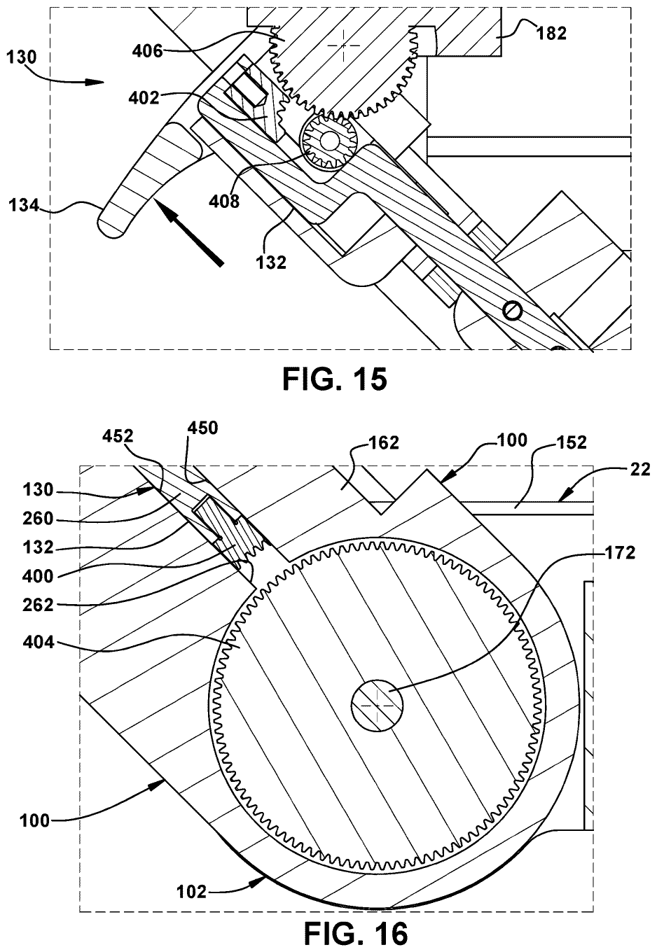

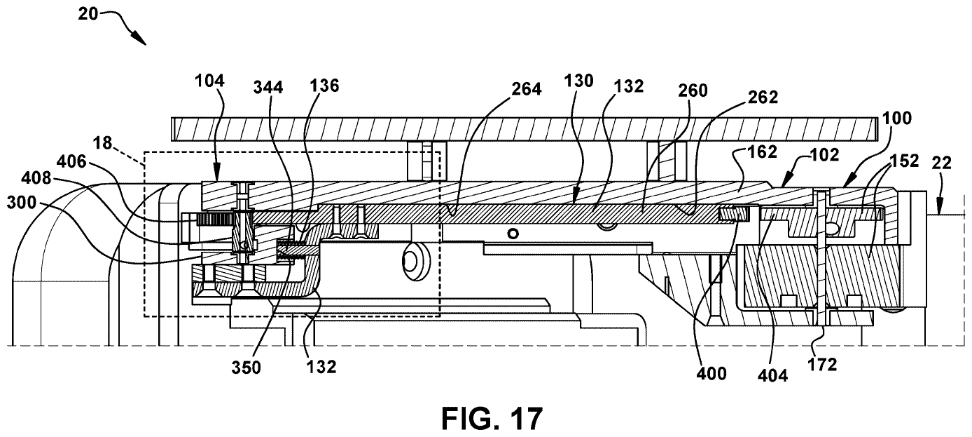

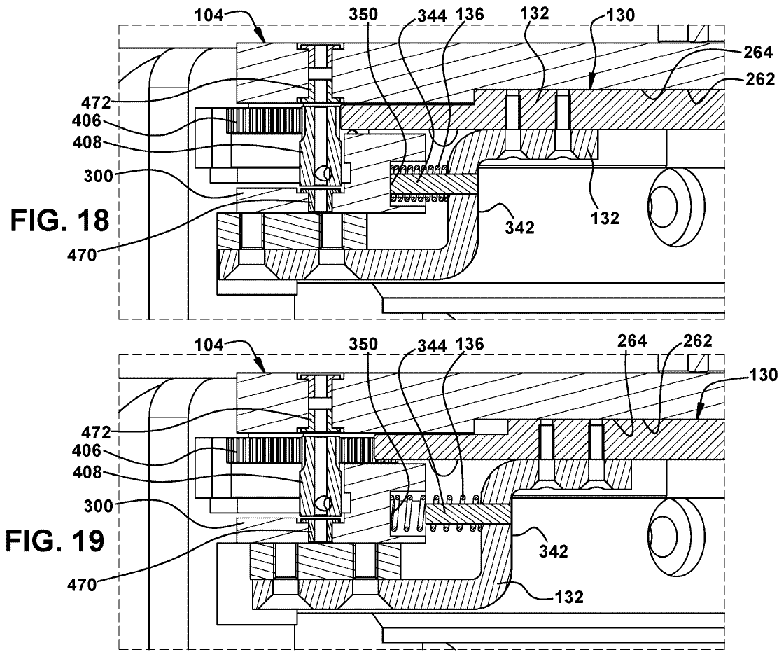

Turning now to FIGS. 20-22, and with continued reference to FIGS. 10-19, an example of operation of the adjustable headrest 20 will now be described in greater detail. FIG. 21 shows the adjustable headrest 20 including the frame 100 and head support plate 120 thereof locked in a horizontal position. To adjust the frame 100 and the head support plate 120 pivotably from the position shown in FIG. 21 to the position shown in FIG. 20, the operator pulls on the user handle 134 of the lock-unlock actuator 130 against the spring bias force of the spring 136 from the locked position shown for example in FIG. 19 to the unlocked position shown for example in FIGS. 17-18, which operates to compress the spring 136, and to disengage the primary mating gear 400 with respect to the primary arc shape gear 404 as shown in FIG. 16 and disengage the secondary mating gear 402 with respect to the secondary arc shape gear 406 as shown in FIG. 15. The operator may then pivot the frame 100 with respect to the attachment member 22 for example clockwise 45 degrees from FIG. 21 to FIG. 20, and likewise pivot the head support plate 120 with respect to the frame 100 for example counterclockwise 45 degrees from FIG. 21 to FIG. 20. The operator may then release the user handle 134, whereby the spring bias force of the spring 136 will return the lock-unlock actuator 130 from the unlocked position shown for example in FIGS. 17-18 to the locked position shown for example in FIG. 19, thereby locking adjustable headrest 20 in the position shown in FIG. 20. To pivot the adjustable headrest 20 from the FIG. 21 position to the FIG. 22 position, the operator may pull the user handle 134 (in FIG. 21), pivot the frame 100 of the adjustable headrest 20 to the FIG. 22 position, then release the user handle 134 to lock the adjustable headrest 20 in the FIG. 22 position.

Referring to FIG. 10, it can be seen that in the locked position the linearly displaceable bar 132 of the lock-unlock actuator 130 is configured to lock the frame 100 and lock the head support plate 120 simultaneously. Further, referring to FIGS. 10 and 14, it can be seen that when the lock-unlock actuator 130 is pulled from the locked position shown in FIG. 10 to the unlocked position shown in FIG. 14, the linearly displaceable bar 132 is configured to unlock the frame 100 and unlock the head support plate 120 simultaneously.

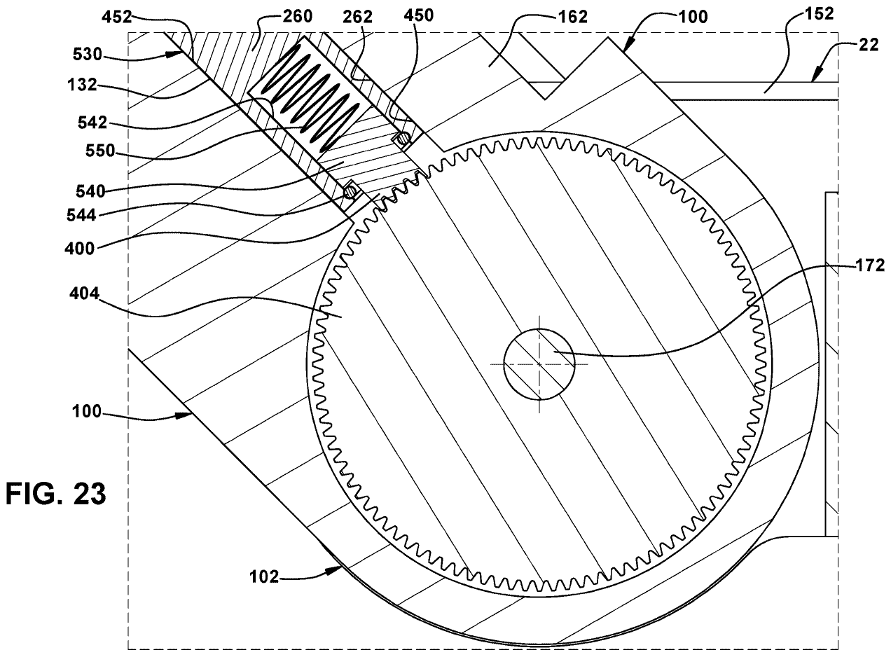

FIGS. 23-26 show a lock-unlock actuator 530 in accordance with another embodiment of the invention. The FIGS. 23-26 lock-unlock actuator 530 is in many respects similar to the above-described lock-unlock actuator 130, and consequently the same reference numerals are used to denote structures corresponding to similar structures in the lock-unlock actuator 130. In addition, the foregoing description of the lock-unlock actuator 130, including the linearly displaceable bar 132, the user handle 134, the spring 136, and the primary mating gear 400, is equally applicable to the FIGS. 23-26 lock-unlock actuator 530 except as noted below. Moreover, it will be appreciated upon reading and understanding the specification that aspects of the lock-unlock actuators 130, 530 may be substituted for one another or used in conjunction with one another where applicable.

Turning then to FIG. 23, the primary mating gear 400 of the lock-unlock actuator 530 includes a sliding element 540 slidably received in a slightly larger size cavity, receptacle, or cylinder 542 in the end of the intermediate elongated member 260 of the linearly displaceable bar 132. The primary mating gear 400 may be retained within the cylinder 542 by a retaining ring 544. A spring 550, in the illustrated embodiment a linear compression spring, is provided within the cylinder 542 to exert a spring bias force against the primary mating gear 400 in a direction away from a bottom wall of the cylinder 542 in the intermediate elongated member 260 and toward the primary arc shape gear 404.

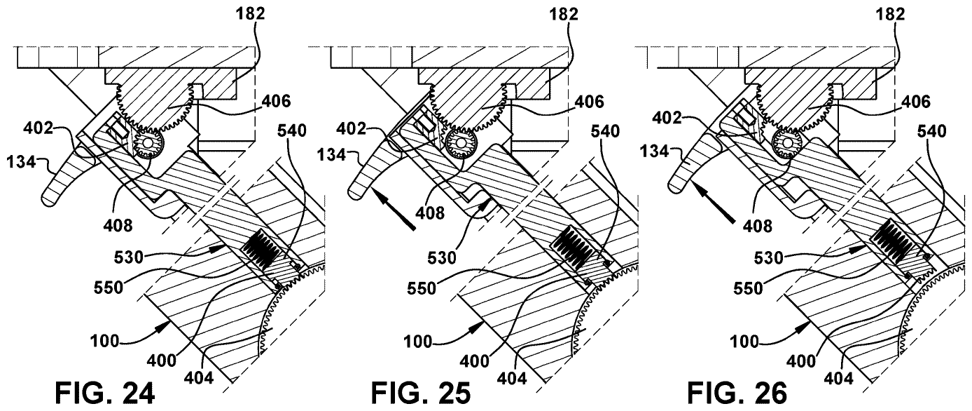

The primary mating gear 400 equipped with the sliding element 540 enables three different operating conditions. FIG. 24 shows a first operating condition wherein the lock-unlock actuator 530 is in a locked position and the spring 550 is fully compressed within the cylinder 542. Here the primary mating gear 400 is engaged with respect to the primary arc shape gear 404 to lock the frame 100 pivotably against lowering of the distal end 104 of the frame 100 relative to the attachment member 22. Also, the secondary mating gear 402 is engaged with respect to the secondary arc shape gear 406, in the illustrated embodiment via the pinion gear 408, to lock the head support plate 120 pivotably relative to the frame 100. As such, the frame 100 cannot be pivoted relative to the attachment member 22 and the head support plate 120 cannot be pivoted relative to the frame 100.

FIG. 25 shows a second operating condition wherein the lock-unlock actuator 530 is in a partially retracted position, that is an intermediate position that is between the locked position and a fully retracted unlocked position, and the spring 550 is partially compressed within the cylinder 542, that is, less compressed than in the FIG. 24 fully compressed state. Here the primary mating gear 400 remains engaged with respect to the primary arc shape gear 404 to keep the frame 100 locked pivotably against lowering of the distal end 104 of the frame 100 relative to the attachment member 22. However, the secondary mating gear 402 is disengaged with respect to the secondary arc shape gear 406, in the illustrated embodiment via the pinion gear 408, to unlock the head support plate 120 pivotably relative to the frame 100. As such, although the frame 100 cannot be pivoted relative to the attachment member 22, the head support plate 120 can be pivoted relative to the frame 100. This allows an operator to adjust the head support plate 120 pivotably relative to the frame 100 for example while the frame 700 is locked pivotably relative to the attachment member 22, or after having pivoted and locked the frame 100 relative to the attachment member 22.

FIG. 26 shows a third operating condition wherein the lock-unlock actuator 530 is in a fully retracted unlocked position, and the spring 550 is uncompressed. Here the primary mating gear 400 is disengaged with respect to the primary arc shape gear 404 to unlock the frame 100 pivotably relative to the attachment member 22 to allow lowering of the distal end 104 of the frame 100 relative to the attachment member 22. Also, the secondary mating gear 402 is disengaged with respect to the secondary arc shape gear 406, in the illustrated embodiment via the pinion gear 408, to unlock the head support plate 120 pivotably relative to the frame 100. As such, the frame 100 can be pivoted relative to the attachment member 22 and the head support plate 120 can be pivoted relative to the frame 100. This allows an operator both to adjust the head support plate 120 pivotably relative to the frame 100 and to adjust the frame 100 pivotably relative to the attachment member 22, simultaneously if desired.

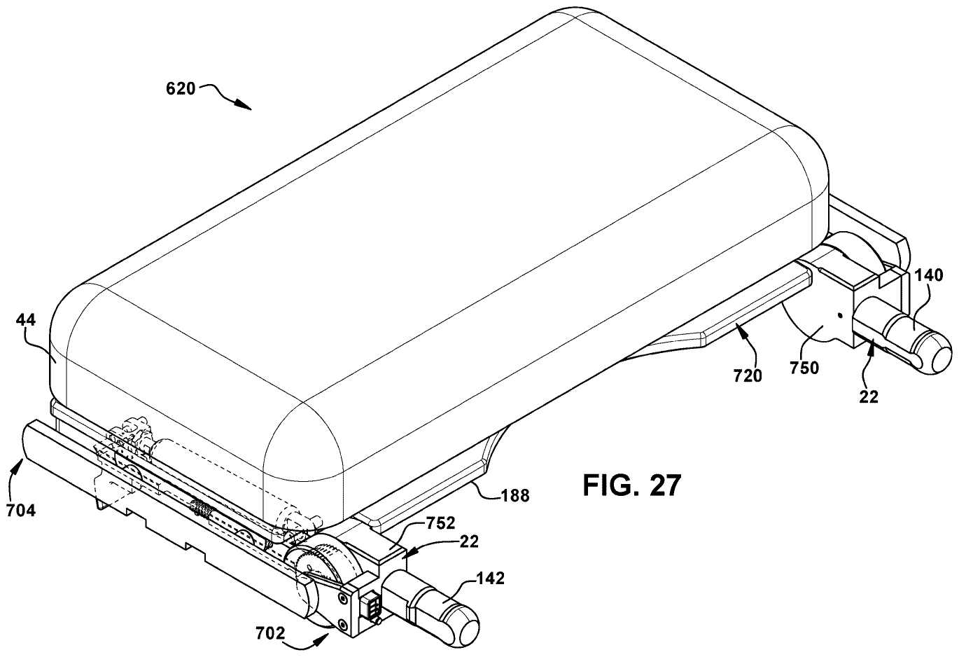

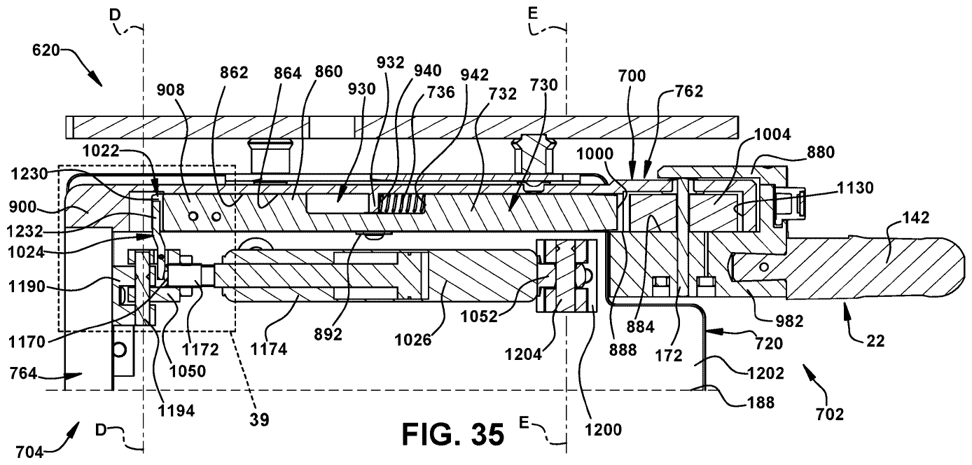

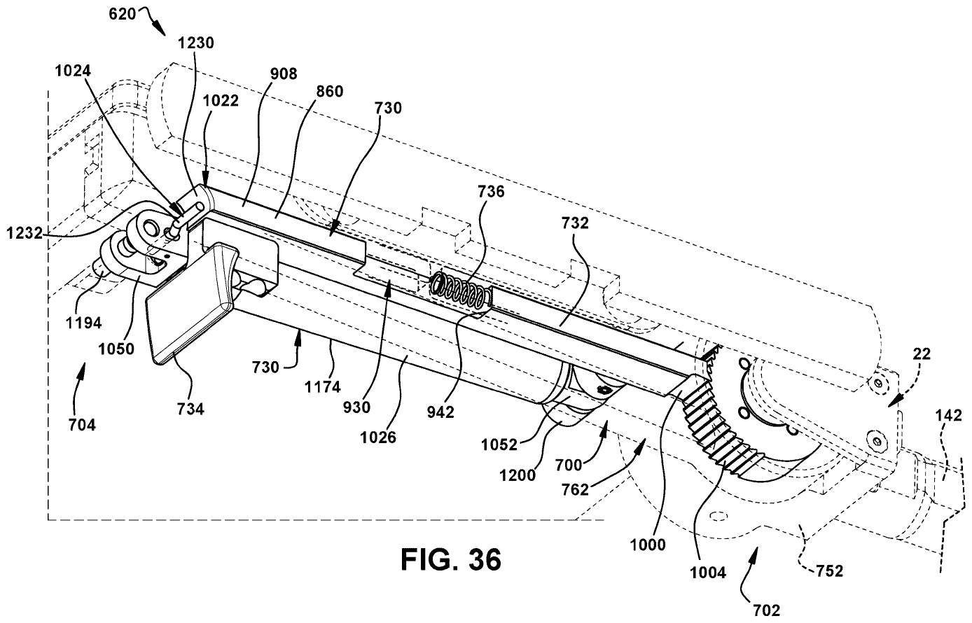

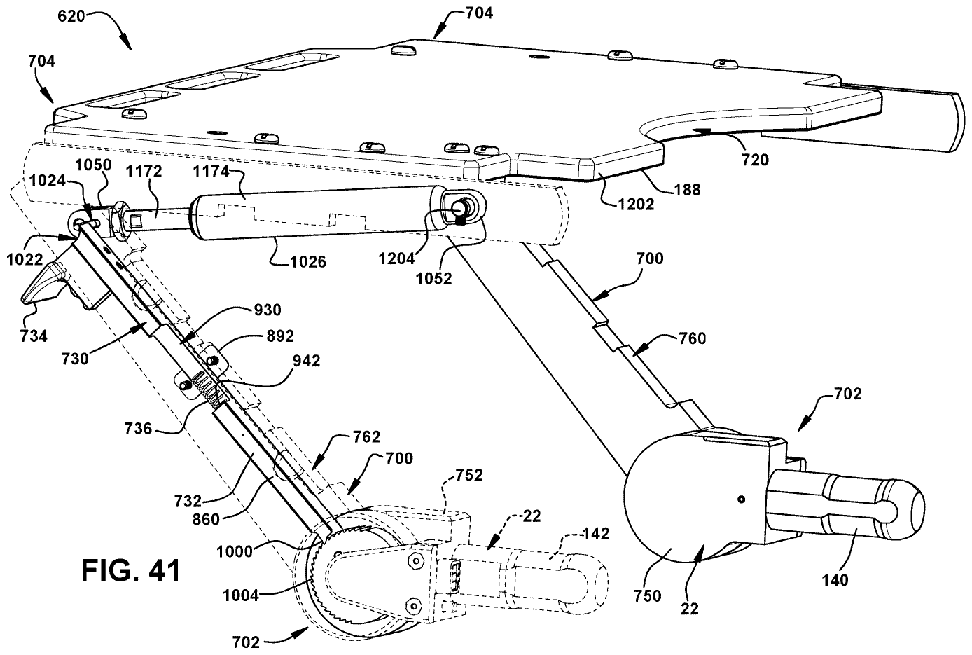

FIGS. 27-48 show an adjustable headrest 620 in accordance with another embodiment of the invention. The FIGS. 27-48 adjustable headrest 620 is in many respects similar to the above-described adjustable headrest 20, and consequently the same reference numerals are used to denote structures corresponding to similar structures in the adjustable headrest 20. In addition, the foregoing description of the adjustable headrest 20, including the components thereof, is equally applicable to the FIGS. 27-48 adjustable headrest 620 except as noted below. Moreover, it will be appreciated upon reading and understanding the specification that aspects of the adjustable headrests 20, 620 may be substituted for one another or used in conjunction with one another where applicable.

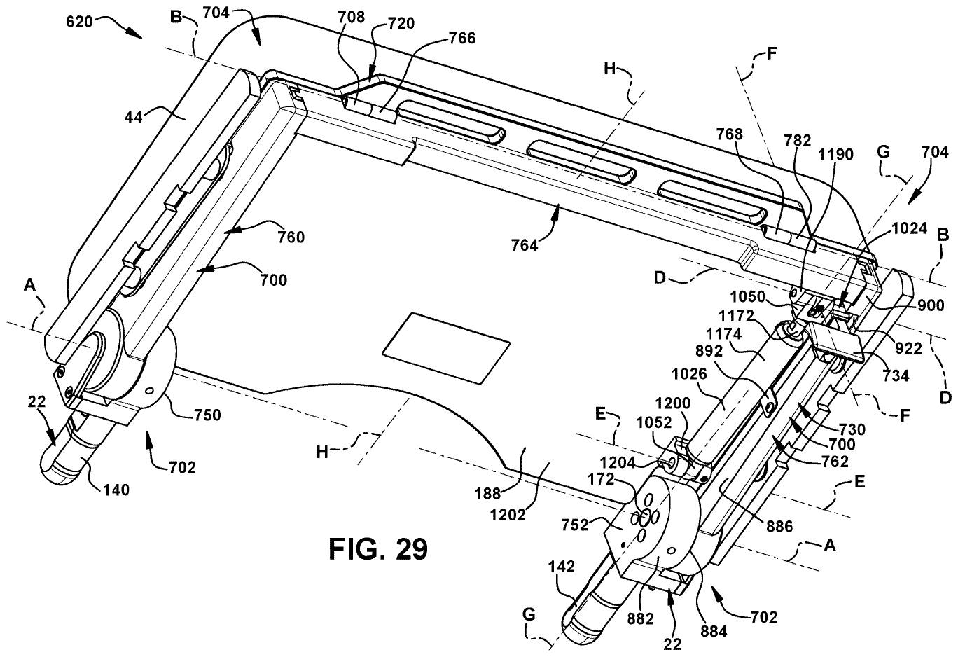

As shown in FIGS. 27-31, the adjustable headrest 620 includes a frame 700, a head support plate 720, and a lock-unlock actuator 730 having a linearly displaceable bar 732 and a user handle 734. The frame 700 has a proximal end 702 and a distal end 704. As generally shown in FIGS. 29-30 and 45-47, the proximal end 702 of the frame 700 is mounted for pivotable movement relative to the attachment member 22 to raise and lower the distal end 704 of the frame 700 relative to the attachment member 22 and the upper torso section 70 to which the attachment member 22 is attached (see FIG. 1). The head support plate 720 is mounted for pivotable movement relative to the frame 700, in the illustrated embodiment the distal end 704 thereof, to tilt the head support plate 720 relative to the frame 700. The patient support surface 42 of the adjustable headrest 620 may include a cushion 44 that is attached to an upper surface of the head support plate 720.

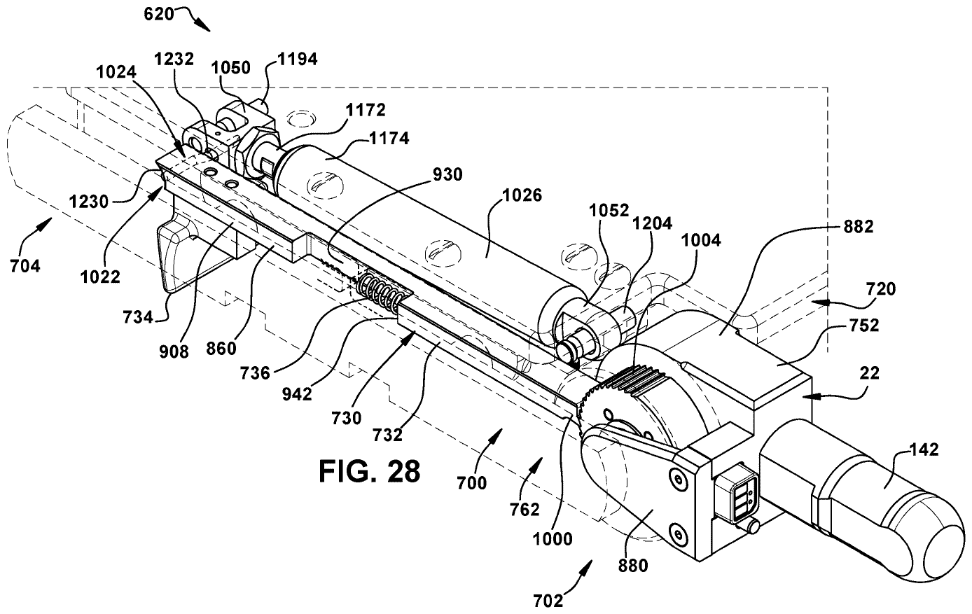

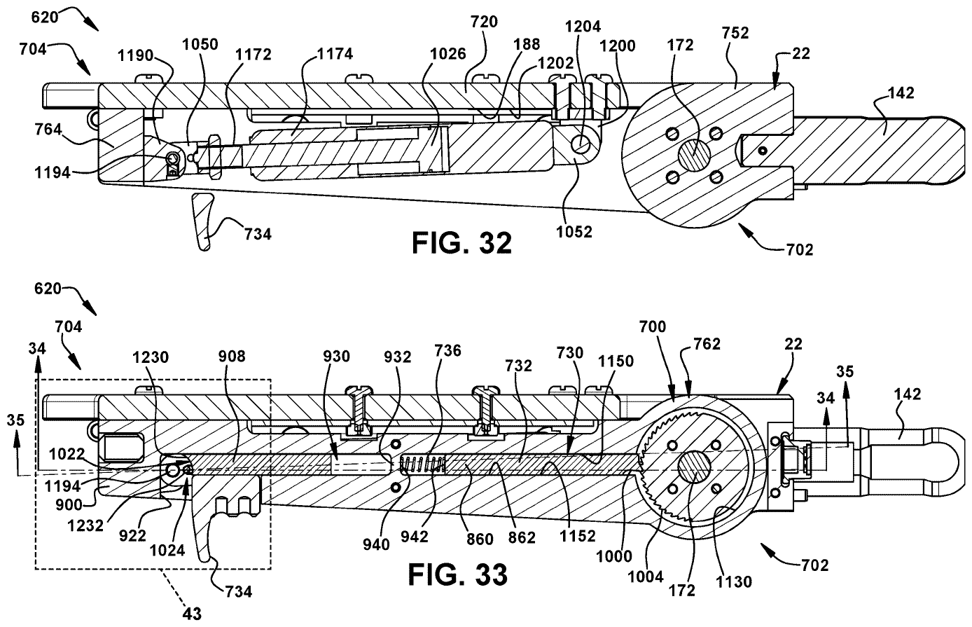

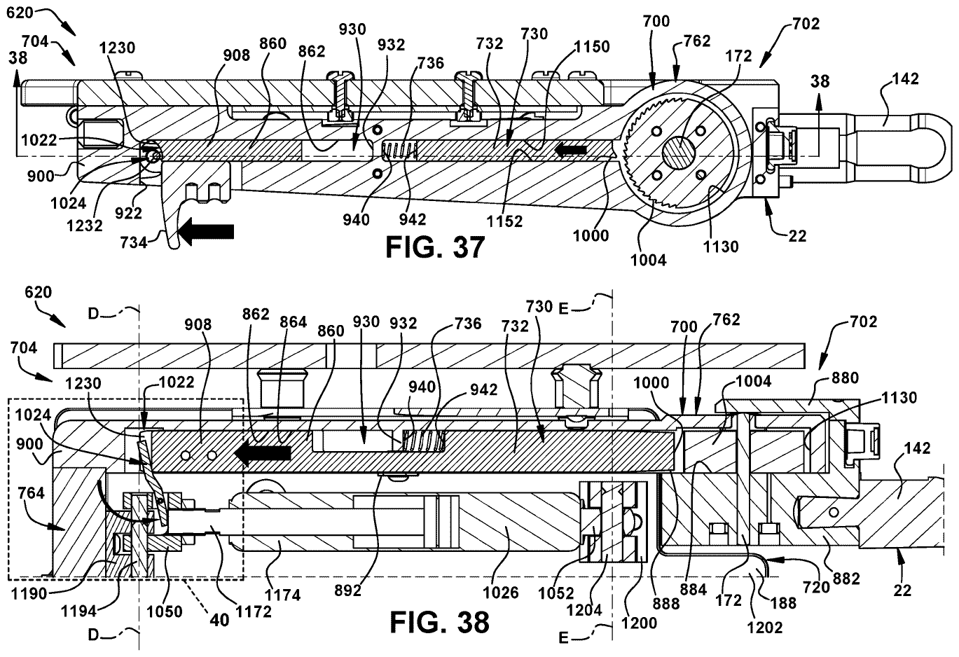

Referring to FIGS. 32-38, the linearly displaceable bar 732 of the lock-unlock actuator 730 is supported and slidably guided by the frame 700 for translating movement. The linearly displaceable bar 732 is translatable between a locked position, shown for example in FIGS. 28, 32-36, 39, 41-44 and 48, and a unlocked position, shown for example in FIGS. 37-38 and 40. The linearly displaceable bar 732 is spring biased, for example by a spring 736, to move from the unlocked position to the locked position. The user handle 734 of the lock-unlock actuator 730 is configured to move the linearly displaceable bar 732 against the spring bias force of the spring 736 from the locked position to the unlocked position. In the locked position the linearly displaceable bar 732 is configured to lock the frame 700 pivotably against lowering of the distal end 704 of the frame 700 relative to the attachment member 22 and to lock the head support plate 720 pivotably relative to the frame 700. Further, in the unlocked position the linearly displaceable bar 732 is configured to unlock the frame 700 pivotably relative to the attachment member 22 to allow lowering of the distal end 704 of the frame 700 relative to the attachment member 22 and to unlock the head support plate 720 pivotably relative to the frame 700.

As will be described in greater detail below, several advantages may be realized by the components of the adjustable headrest 620 in accordance with the invention. For example, an operator can use the user handle 734 to pull the linearly displaceable bar 732 to release both the frame 700 relative to the tabletop 40 and the head support plate 720 relative to the frame 700, so that either of the frame 700 and/or the head support plate 720 can be pivotably adjusted to a desired angular position. The operator can then release the user handle 734 whereby the spring bias force of the spring 736 returns the linearly displaceable bar 732 to the locked position to pivotably lock the frame 700 and head support plate 720 in place. Thus, only one operator input point, that is the user handle 734, is required to lock/unlock two rotational freedoms, that is, the pivot connection between the frame 700 and the surgical table 10, and the pivot connection between the head support plate 720 and the frame 700.

Turning initially then to FIGS. 27-31, the attachment member 22 of the adjustable headrest 620 includes left and right shafts 140, 142. The attachment member 22 optionally may also include a cross beam 144 extending between and fixed relative to the left and right shafts 140, 142, as in the attachment member 22 of the adjustable headrest 20, see FIGS. 2-6 and 8. The left and right shafts 140, 142 are configured to be inserted into mating receptacles (not shown) at an attachment location of the surgical table 10, which in the illustrated embodiment is the upper torso support 70. Inserting the shafts 140, 142 into the receptacles attaches the attachment member 22 and thus the adjustable headrest 620 to the surgical table 10.

Referring to FIGS. 28-31, 36, 41 and 42, the attachment member 22 includes left and right lugs 750, 752 protruding in a direction opposite the respective left and right shafts 140, 142. The frame 700 of the adjustable headrest 620 includes left and right side frame members 760, 762 that are pivotably mounted to the respective left and right lugs 750, 752 via respective pivot joints 170, 172 that share a common pivot axis A-A. The pivot joints 170, 172 enable the left and right side frame members 760, 762 and thus the frame 700 to pivot relative to the attachment member 22 about the pivot axis A-A. The frame 700 also includes a distal end cross beam 764 extending between and fixedly attached to the left and right side frame members 760, 762. Mounted to the distal end cross beam 764 are left and right hinge leaves 766, 768. As shown in FIGS. 29-31, 42 and 44, the head support plate 720 includes corresponding left and right hinge leaves 780, 782 attached to an underside 188 of the head support plate 720. The left and right hinge leaves 780, 782 are pivotably mounted to the respective left and right hinge leaves 766, 768 of the distal end cross beam 764 of the frame 700 via respective knuckle pivot joints that share a common pivot axis B-B, also referred to as a hinge connection pivot axis B-B herein, the pivot axis B-B being parallel to the pivot axis A-A. The hinged connections of the respective left and right hinge leaves 766, 768, 780, 782 enable the head support plate 120 to pivot relative to the frame 700 about the pivot axis B-B.

The distal end cross beam 764 of the frame 700, as well as the attachment of the attachment member 22 to the surgical table 10, maintains the axial spacing between the proximal and distal ends 702, 704 of the left and right side frame members 760, 762 as the frame 700 is pivoted about the pivot axis A-A and the head support plate 120 is pivoted about the pivot axis B-B. In an alternate embodiment, the distal end cross beam 764 may be omitted and a cross beam may be provided at the proximal end 702 in a manner similar to that of the cross beam 144 of the adjustable headrest 20.

Although not shown, the head support plate 720 may also include a pair of rails depending from the underside 188 of the head support plate 720 at respective left and right side portions of the head support plate 720 in a manner similar to that of the pair of rails 200, 202 of the adjustable headrest 20, see FIGS. 2 and 5. The pair of rails may define therebetween a rectangular imaging volume under the head support plate 720 for slidably receiving an X-ray board or the like. The pair of rails may have an L-shape with their respective bottom leg portions facing toward the centerline H-H of the head support plate 720 to support an X-ray board. The axial distance, or left-to-right distance, between the left and right rails may be such that the rails can fit within the space provided between the left and right side frame members 760, 762 when the head support plate 720 and the frame 700 are positioned adjacent one another, that is, when the head support plate 720 is not tilted relative to the frame 700, as shown in FIGS. 46 and 47, for example.

Also, although not shown, the left side frame member 760 and the left lug 750 of the attachment member 22 may house a torsion spring in a manner similar to that of the torsion spring 230 of the adjustable headrest 20, see FIGS. 5 and 6. The torsion spring biases the left side frame member 760, and by connection the head support plate 720 and the right side frame member 762, in a direction to raise the distal end 704 of the frame 700 relative to the attachment member 22. In this way, the torsion spring aids in supporting the load on the head support plate 720 and the frame 700 and thus provides positioning assistance to the operator as the operator adjusts the adjustable headrest 620. The torsion spring also reduces the contact pressure on the components of the lock-unlock actuator 730 so that adjustments of the adjustable headrest 620 by the operator are smoother. As will be appreciated, the torsion spring may alternately be provided in the right side frame member 762, or torsion springs may be provided in both the left and right side frame members 760, 762.

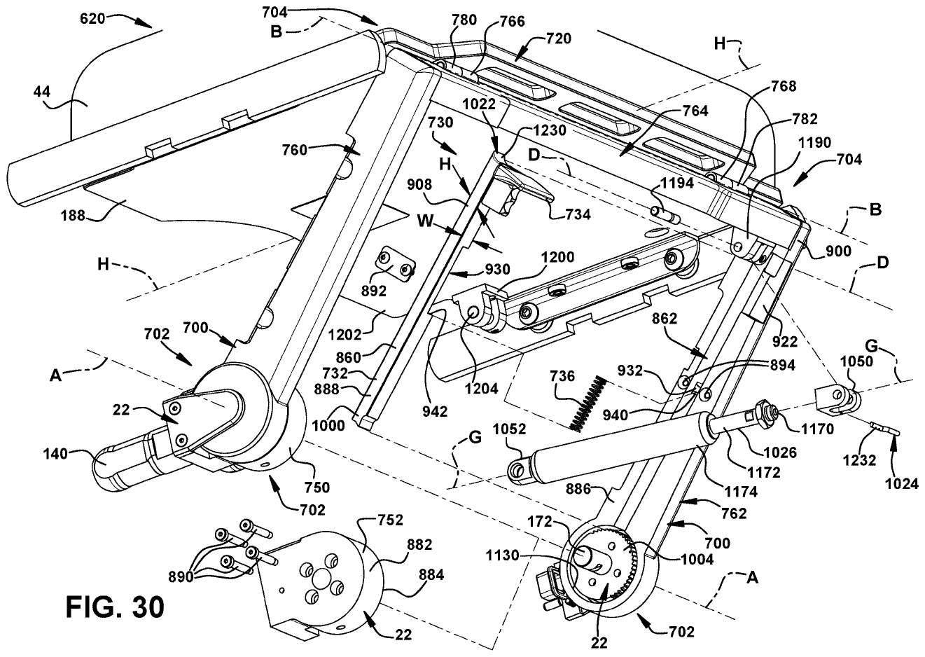

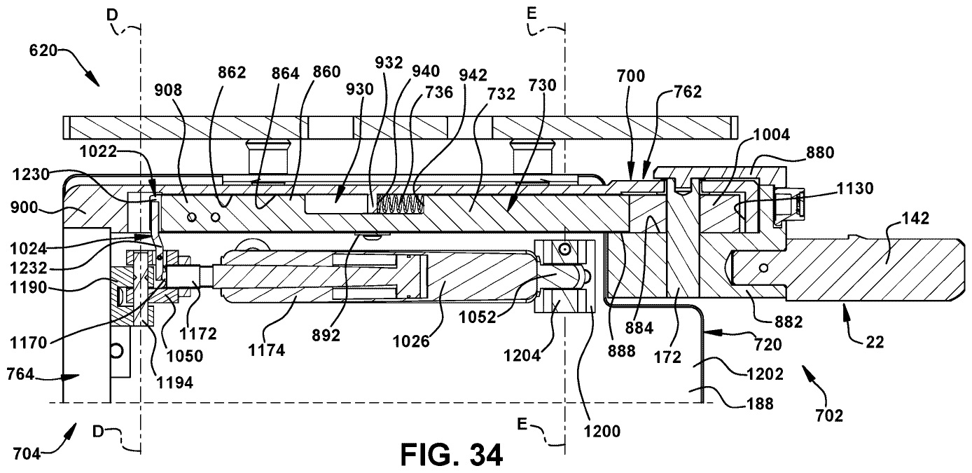

With reference to FIGS. 28-30, 33-36 and 41-42, the lock-unlock actuator 730 will now be described in greater detail. As shown in FIGS. 30, 33-35 and 41-42, the linearly displaceable bar 732 of the lock-unlock actuator 730 includes an intermediate elongated member 860 that is positioned within a channel 862 of the right side frame member 862. The channel 862 is sized to support and slidably guide the intermediate elongated member 860 for linear translation movement. In the illustrated embodiment, the intermediate elongated member 860 has a rectangular cross section and the channel 862 likewise has a rectangular cross section. The height of the channel 862 is slightly greater than the height H of the intermediate elongated member 860, see FIG. 30, to retain the intermediate elongated member 860 vertically within the channel 862 while permitting translating movement of the intermediate elongated member 860 within the channel 862. The width of the channel 862 is slightly greater than the width W of the intermediate elongated member 860. The channel 862 includes a leftward facing side 864, see FIGS. 34, 35 and 38-40, to retain the rightward facing side of the intermediate elongated member 860 laterally within the channel 862 while permitting translating movement of the intermediate elongated member 860 within the channel 862.

At the proximal end 702 of the right side frame member 762, the right lug 752 of the attachment member 22 is in the form of a clevis having first and second clevis arms 880, 882, see FIGS. 30-31 and 34-36, within which the proximal end 702 of the right side frame member 762 is received. As shown in FIGS. 30-31 and 34, a rightward facing side 884 of the second clevis arm 882 is mounted in sliding abutting contact to a leftward facing side 886 of the right side frame member 762, for example by fasteners 890 mounted through corresponding through holes in the second clevis arm 882 and into corresponding threaded openings in a side wall of a later described primary arc shape gear 1004 of the attachment member 22. In this way, the second clevis arm 882 retains a leftward facing side 888 of the intermediate elongated member 860 laterally within the channel 862 at the proximal end 702 of the right side frame member 762 while permitting translating movement of the intermediate elongated member 860 within the channel 862. The clevis formed by the first and second clevis arms 880, 882 is mounted to the pivot joint 172, which pivotably mounts the right side frame member 762 to the attachment member 22 as described above.

In the illustrated embodiment, additional lateral support for the intermediate elongated member 860 is also provided by a side bracket 892. As shown in FIGS. 29-31 and 34, the side bracket 892 is fastened to the leftward facing side 886 of the right side frame member 762 by upper and lower fasteners threaded into openings in the right side frame member 762 respectively above and below the channel 862. In this way, the side bracket 892 retains the leftward facing side 888 of the intermediate elongated member 860 laterally within the channel 862 at a position between the proximal end 702 and distal end 704 of the right side frame member 762 while permitting translating movement of the intermediate elongated member 860 within the channel 862.

The right side frame member 762 at its distal end 704 includes a retaining portion 900, which is shown in greater detail in FIGS. 29-30 and 33-34. The retaining portion 900 may be attached to the distal end cross beam 764 of the frame 700 for example by not shown fasteners or may be formed integrally with the distal end cross beam 764, for example as a monolithic component. The retaining portion 900 includes a distal end of the channel 862 and receives therein the distal end 908 of the intermediate elongated member 860. In this way, the leftward facing side 864 of the channel 862 laterally retains a distal end portion 908 of the intermediate elongated member 860 therein and thus laterally retains the intermediate elongated member 260 within the channel 862 at the distal end 704 of the right side frame member 762 while permitting translating movement of the intermediate elongated member 860 within the channel 862.

The user handle 734 of the lock-unlock actuator 730 is attached to a bottom wall 920 of the intermediate elongated member 860 by not shown fasteners or may be formed integrally with the intermediate elongated member 860, for example as a monolithic component. As shown in FIGS. 29-30 and 33, a portion of the user handle 734 protrudes downward relative to the distal end 704 of the frame 700 through a downward protruding opening 922 in the retaining portion 900 of the right side frame member 762 in the front right corner of the adjustable headrest 620, providing easy access to the user handle 734 by the operator.

With continued reference to FIGS. 28, 30 and 33-36, the spring 736 of the lock-unlock actuator 730 is positioned relative to the right side frame member 762 and the linearly displaceable bar 732 to generate a spring bias force on the linearly displaceable bar 732 in a direction from the distal end 704 to the proximal end 702 of the right side frame member 762. In the illustrated embodiment, the intermediate elongated member 860 includes a recess 930 projecting leftward into the rightward facing side of the intermediate elongated member 860 about halfway through the width W of the intermediate elongated member 860. The right side frame member 762 includes a projection wall 932 that projects from the leftward facing side 864 of the channel 862 into the recess 930 of the intermediate elongated member 860 about halfway through the width of the channel 862. In the illustrated embodiment, the projection wall 862 is at the same position along the longitudinal axis of the channel 862, or between the proximal end 702 to distal end 704 of the right side frame member 762, as the afore described side bracket 892. As shown in FIGS. 33-36, the spring 736 is sandwiched between an end wall 940 of the projection wall 932 of the right side frame member 762 and an end wall 942 of the recess 930 of the linearly displaceable bar 732. Together the upper and lower walls of the channel 862, the rightward facing side or bottom of the recess 930, and the leftward facing side of the channel 862, allow the spring 736 to compress between the two end walls 940, 942 while also preventing radial or lateral shifting of the spring 736, thereby retaining the spring 736 between the two end walls 940, 942.

As will be described in greater detail below with respect to FIGS. 32-44, the lock-unlock actuator 730 includes a pawl 1000 that is configured for selective engagement relative to a primary arc shape gear 1004 of the attachment member 22, wherein the pawl 1000 and the primary arc shape gear 1004 form a ratchet and pawl mechanism that allows pivotable movement in one direction while preventing pivotable movement in an opposite direction. In the locked position shown for example in FIGS. 32-36, 39 and 41-44, the linearly displaceable bar 732 of the lock-unlock actuator 730 is configured to engage the pawl 1000 with respect to the primary arc shape gear 1004 to lock the frame 700 pivotably against lowering of the distal end 704 of the frame 700 relative to the attachment member 22, and in the unlocked position shown for example in FIGS. 37-38 and 40, the linearly displaceable bar 732 is configured to disengage the pawl 1000 with respect to the primary arc shape gear 1004 to unlock the frame 700 pivotably relative to the attachment member 22 to allow lowering of the distal end 704 of the frame 700 relative to the attachment member 22.

The adjustable headrest 620 also includes a locking gas spring 1026, which, as will be described in greater detail below, has a frame connection end 1050 at one end thereof and a plate connection end 1052 at an opposite end thereof, the locking gas spring 1026 being pivotably mounted at the frame connection end 1050 to the frame 700 and pivotably mounted at the plate connection end 1052 to the head support plate 720. The lock-unlock actuator 730 includes a force transfer member 1024 configured to transfer force from an actuating member 1022 of the linearly displaceable bar 732 to the locking gas spring 1026 to selectively lock and unlock the locking gas spring 1026. In the locked position the linearly displaceable bar 732 is configured to reduce the force from the actuating member 1022 on the force transfer member 1024 to lock the locking gas spring 1026, thereby to lock the head support plate 720 pivotably relative to the frame 700, and in the unlocked position the linearly displaceable bar 732 is configured to increase the force from the actuating member 1022 on the force transfer member 1024 to unlock the locking gas spring 1026, thereby to unlock the head support plate 720 pivotably relative to the frame 700.

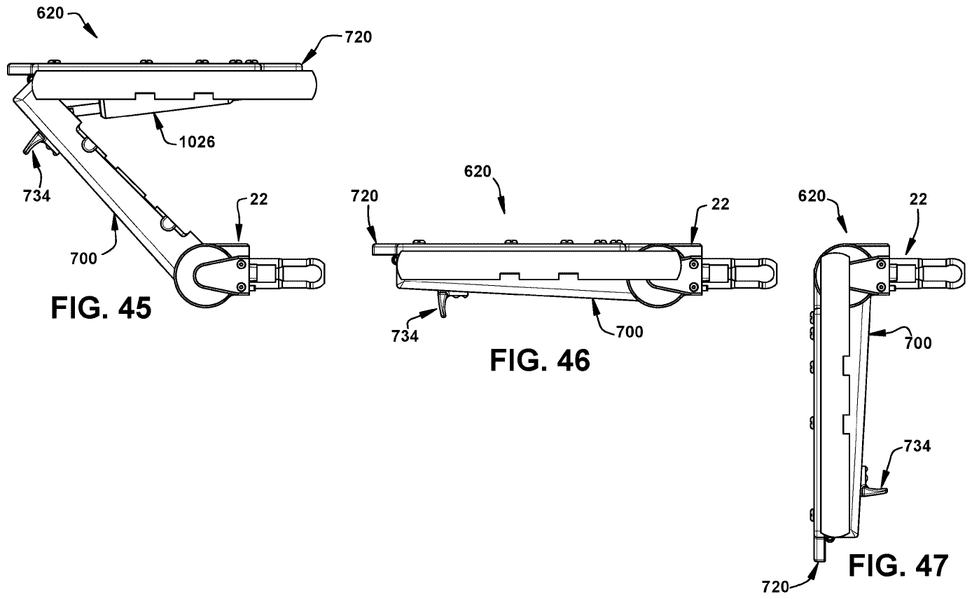

The primary arc shape gear 1004 is attached to the right lug 752 of the attachment member 22 for example by not shown fasteners or may be formed integrally with the right lug 752, for example as a monolithic component. In the illustrated embodiment, the primary arc shape gear 1004 is circular in shape and is received in a slightly larger diameter circular recess 1130 in the proximal end 702 of the right side frame member 762 of the frame 700. The centers of the primary arc shape gear 1004 and the circular recess 1130 coincide with the afore described pivot axis A-A. The illustrated primary arc shape gear 1004, although having an overall circular or 360 degree arc shape, has a gear teeth portion arc of less than 360 degrees, that is, a fan shape or sector shape of about 180 degrees. The amount of gear teeth portion arc of the primary arc shape gear 1004, whether the overall shape of the primary arc shape gear 1004 is circular or less than 360 degree arc shape, typically will depend on the desired range of angular positions of the frame 700 relative to the attachment member 22, that is, the desired range of pivot about the pivot axis A-A of the proximal end 702 of the frame 700 relative to the attachment member 22. For example, for the range of pivot in FIGS. 45-47, the primary arc shape gear 1004 may be a sector gear of 135 degrees, accounting for the 45 degree pivot in the clockwise direction relative to horizontal in FIG. 45 and the 90 degree pivot in the counterclockwise direction relative to horizontal in FIG. 47.

The pawl 1000 is formed integrally with the intermediate elongated member 860, for example as a monolithic component, or may be attached to an end of the intermediate elongated member 860 for example as by a threading engagement. As shown in FIGS. 28, 33, 36 and 42, the tooth of the pawl 1000 has a complementary shape to the steps formed between gear teeth of the primary arc shape gear 1004. In the illustrated embodiment, the lock-unlock actuator 730 and the frame channel 862 are configured such that when the linearly displaceable bar 732 is translated to the locked position, the pawl 1000 protrudes from the channel 862 and into the circular recess 1130 for engagement with respect to the primary arc shape gear 1004, and such that when the linearly displaceable bar 732 is translated to the unlocked position, the pawl 1000 retracts out of the circular recess 1130 and back into the channel 862 and thereby out of engagement with respect to the primary arc shape gear 1004.

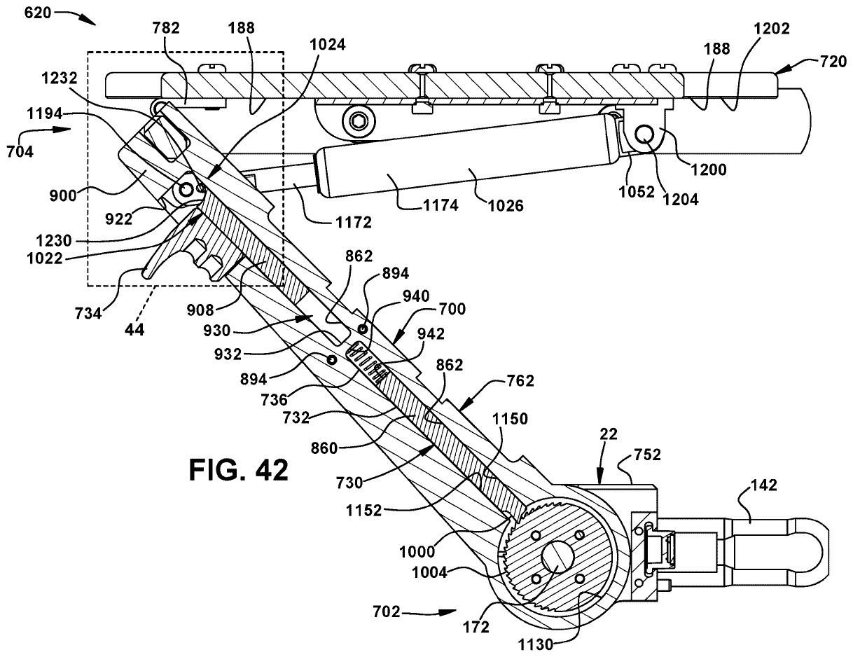

When the pawl 1000 is engaged with respect to the primary arc shape gear 1004, as shown in 28, 33, 36 and 42, the primary arc shape gear 1004 in combination with an upper surface 1150 of the channel 862 prevents downward movement of the pawl 1000 and the intermediate elongated member 860 of which it is a part, thereby preventing counterclockwise pivotable movement, as viewed in FIGS. 33 and 42, of the proximal end 702 of the right side frame member 762 of the frame 700 about the pivot axis A-A, and thereby locking the frame 700 pivotably against lowering of the distal end 704 of the frame 700 relative to the attachment member 22. Thus, for example, referring to FIGS. 33 and 42, a counterclockwise force on the frame 700 will cause the upper surface 1150 of the channel 862 to exert a downward force on the linearly displaceable bar 732 including the pawl 1000 thereof, causing the tooth of the pawl 1000 to exert a downward force that is opposed by an upward force by the tooth of the primary arc shape gear 1004 of the attachment member 22.

However, the ratchet and pawl mechanism formed by the pawl 1000 and primary arc shape gear 1004 enables pivotable movement of the frame 700 in the opposite direction, that is, in the clockwise direction in FIGS. 33 and 42. As a ratchet and pawl mechanism, the pawl 1000 is configured to retract or move leftward in FIGS. 28, 33, 36 and 42, against the spring bias force of the spring 736 as the pawl 1000 slides along the ramp of a tooth of the primary arc shape gear 1004. When the pawl 1000 is engaged with respect to the primary arc shape gear 1004, as shown in FIGS. 28, 33, 36 and 42, the primary arc shape gear 1004 in combination with a lower surface 1152 of the channel 862 allows upward movement of the pawl 1000 and the intermediate elongated member 860 of which it is a part, thereby allowing clockwise pivotable movement, as viewed in FIGS. 33 and 42, of the proximal end 702 of the right side frame member 762 of the frame 700 about the pivot axis A-A, and thereby allowing raising of the distal end 704 of the frame 700 relative to the attachment member 22. Thus, a clockwise force on the frame 700 will cause the lower surface 1152 of the channel 862 to exert an upward force on the linearly displaceable bar 732 including the pawl 1000 thereof, causing the tooth of the pawl 1000 to exert a force against the ramp of the tooth of the primary arc shape gear 1004 of the attachment member 22. As the frame 700 is moved pivotably clockwise about the pivot axis A-A, the pawl 1000 rides up the ramp. The ramp exerts an opposing force on the pawl 1000 that urges the linearly displaceable bar 732 radially outwardly from the pivot axis A-A and into the channel 862 against the bias force of the spring 736, thereby retracting the pawl 1000 from engagement with respect to the primary arc shape gear 1004 from the locked position to an intermediate ratchet release position. As the frame 700 is moved further clockwise, the pawl 1000 drops into the adjacent step of the primary arc shape gear 1004, thereby reengaging the pawl 1000 with respect to the primary arc shape gear 1004 and returning the linearly displaceable bar 732 from the intermediate ratchet release position to the locked position. In this way, when the linearly displaceable bar 732 is moved to the locked position, as shown in FIGS. 28, 33, 36 and 42, although the linearly displaceable bar 732 locks the frame 700 pivotably against lowering of the distal end 704 of the frame 700 relative to the attachment member 22, the linearly displaceable bar 732 does not lock the frame 700 pivotably against raising of the distal end 704 of the frame 700 relative to the attachment member 22.

Referring now to FIGS. 29-44, the locking gas spring 1026 of the adjustable headrest 620 will now be described in greater detail. The locking gas spring 1026 is positioned adjacent to the lock-unlock actuator 730 when the head support plate 720 is in a non-tilted position relative to the frame 700 of the adjustable headrest 620, as shown for example in FIGS. 45 and 46. The locking gas spring 1026 includes a release pin 1170, see FIGS. 30, 34-35 and 38-40, to selectively extend and retract a piston rod 1172 relative to a cylinder 1174 of the locking gas spring 1026. When the release pin 1170 is pressed, the piston rod 1172 exerts a biasing pivotable force that biases the head support plate 720 to tilt away from the frame 700. The biasing pivotable force may assist an operator in tilting the head support plate 720 away from the frame 700 to a desired tilted position. For relatively lighter loads on the head support plate 720, the biasing pivotable force of the locking gas spring 1026 may be sufficient to tilt the head support plate 720 away from the frame 700 with minimal or no operator assistance. For relatively heavier loads on the head support plate 720 operator assistance may be required to tilt the head support plate 720 away from the frame 700 to the desired tilted position. When the release pin 1170 is released, the piston rod 1172 is locked relative to the cylinder 1174 thereby to lock the locking gas spring 1026 and thus lock the head support plate 720 relative to the frame 700 into the desired tilted position.

An exemplary mounting structure of the locking gas spring 1026 is shown in FIGS. 29-35, 38-40 and 42-44. The frame connection end 1050 of the locking gas spring 1026 is pivotably mounted to a lug 1190 projecting from the distal end cross beam 764 of the frame 700 toward the proximal end 702 of the frame 700. The frame connection end 1050 is pivotably mounted to the lug 1190 via a spring-frame connection joint 1194 having a spring-frame connection pivot axis D-D. The plate connection end 1052 of the locking gas spring 1026 is pivotably mounted to a lug 1200 projecting downward from the underside 188 of a free end 1202 of the head support plate 720 via a spring-plate connection joint 1204 having a spring-plate connection pivot axis E-E. In the illustrated embodiment, the joints are clevis joints although it will be appreciated the joints may take on other forms.

When the release pin 1170 of the locking gas spring 1026 is pressed to bias the piston rod 1172 to extend, the locking gas spring 1026 exerts a biasing force between the spring-frame connection pivot axis D-D and the spring-plate connection pivot axis E-E. As previously described, the head support plate 720 is pivotably mounted to the frame 700 via the hinge connection at the pivot axis B-B. As shown in FIG. 29, the pivot axes D-D and E-E are parallel to the afore described pivot axes A-A and B-B. Further, as shown in FIGS. 29, 33, 37 and 42, the spring-frame connection pivot axis D-D is between the hinged connection pivot axis B-B and the spring-plate pivot axis E-E, and the spring-frame connection pivot axis D-D is positioned farther from the underside 188 of the head support plate 720 than the hinged connection pivot axis B-B and the spring-plate pivot axis E-E. As will be appreciated, the frame structure between the spring-frame connection pivot axis D-D and the hinged connection pivot axis B-B defines a moment arm. With the foregoing construction, when the release pin 1170 of the locking gas spring 1026 is pressed to bias the piston rod 1172 to extend, the biasing force exerted by the piston rod 1172 of the locking gas spring 1026 is transmitted through the head support plate 720 to the hinged connection at the pivot axis B-B thereby to generate a moment about the spring-frame connection pivot axis D-D that counters a moment generated by the head support plate 720 and the load thereon, thereby aiding the operator in angularly adjusting the head support plate 720 relative to the frame 700.

Referring now to FIGS. 28, 30 and 33-44, the actuating member 1022 and the force transfer member 1024 of the lock-unlock actuator 730 will now be described in greater detail. The actuating member 1022 includes a cam surface 1230, in the illustrated embodiment situated at an end of the linearly displaceable bar 732. The force transfer member 1024 includes a link 1232 configured to transfer force from the cam surface 1230 to the release pin 1170 of the locking gas spring 1026. The link 1232 is pivotably mounted to the frame connection end 1050 of the locking gas spring 1026 about a link pivot axis F-F, see FIG. 29. As shown in FIGS. 30-31 and 39-40, the link pivot axis F-F is perpendicular to the afore described spring-frame connection pivot axis D-D and perpendicular to an actuation axis G-G of the locking gas spring 1026.

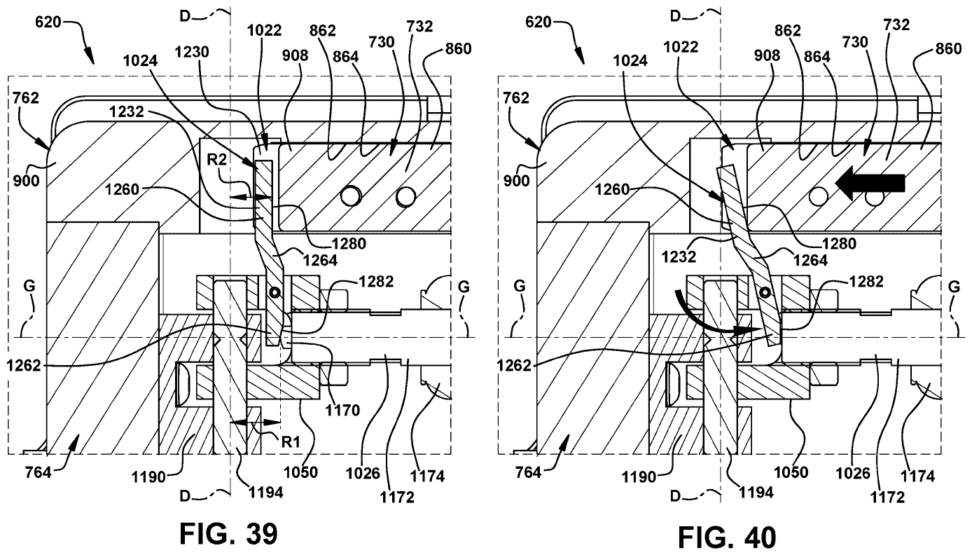

As generally shown in FIGS. 39 and 40, the link 1232 has at opposite ends thereof a cam abutting end 1260 that abuts the cam surface 1230 of the linearly displaceable bar 732 and a release pin abutting end 1262 that abuts the release pin 1170 of the locking gas spring 1026. FIG. 39 shows the link 1232 with the linearly displaceable bar 732 in the locked position, and FIG. 40 shows the link 1232 with the linearly displaceable bar 732 in the unlocked position. The link 1232 is configured such that, in response to the linearly displaceable bar 732 being moved from the locked position to the unlocked position, the cam surface 1230 of the linearly displaceable bar 732 exerts a force that urges the cam abutting end 1260 of the link 1232 in one direction, in the illustrated embodiment a direction toward the spring-frame connection pivot axis D-D (leftward in FIGS. 39 and 40), which, owing to the pivotable movement of the link 1232 about the link pivot axis F-F, translates into the release pin abutting end 1262 of the link 1232 exerting a force in an opposite direction, in the illustrated embodiment a direction away the spring-frame connection pivot axis D-D (rightward in FIGS. 39 and 40), which causes the release pin abutting end 1262 of the link 1232 to press the release pin 1170 of the locking gas spring 1026. With the release pin 1170 in the pressed state, the piston rod 1172 then exerts a biasing pivotable force that biases the head support plate 720 to tilt away from the frame 700, as earlier described.

With continued reference to FIGS. 38 and 40, the locking gas spring 1026 is configured as a stop member to stop linear translation movement of the linearly displaceable bar 732 against retraction beyond the unlocked position. In FIGS. 38 and 40, the locking gas spring 1026 prevents further counterclockwise pivotable movement of the release pin abutting end 1262 of the link 1232 of the force transfer member 1024. As such, the cam abutting end 1260 of the link 1232 prevents further linear translation movement of the linearly displaceable bar 732, that is, stops further leftward movement in FIGS. 38 and 40.

In the illustrated embodiment, the link 1232 includes a jog portion 1264 between the cam abutting end 1260 and the release pin abutting end 1262 that radially offsets a cam abutting face 1280 of the cam abutting end 1260 from a release pin abutting face 1282 of the release pin abutting end 1262. The radial offset provided by the jog portion 1264 allows for a shorter height cam surface 1230 and thus a shorter height linearly displaceable bar 732 and right side frame member 762, resulting in a shorter height profile in the adjustable headrest 620. Referring to FIG. 39, the release pin abutting face 1282 of the release pin abutting end 1262 of the link 1232 is parallel to and radially spaced from the spring-frame connection pivot axis D-D a radial distance R1. The cam abutting face 1280 of the cam abutting end 1260 of the link 1232 is parallel to and radially spaced from the spring-frame connection pivot axis D-D a radial distance R2 that is less than the radial distance R1. The jog portion 1264 thus radially offsets the cam abutting face 1280 of the cam abutting end 1260 from the release pin abutting face 1282 of the release pin abutting end 1262 in a radial direction toward the spring-frame connection pivot axis D-D, that is, such that the cam abutting face 1280 of the cam abutting end 1260 is closer to the spring-frame connection pivot axis D-D than the release pin abutting face 1282 of the release pin abutting end 1262. As will be appreciated, owing to the jog portion 1264 radially offsetting the cam abutting end 1260 closer to the spring-frame connection pivot axis D-D than the release pin abutting end 1262, as the locking gas spring 1026 pivots the head support plate 720, including the frame connection end 1050 thereof to which the link 1232 is pivotably mounted, about the spring-frame connection pivot axis D-D, the arc path of the cam abutting face 1280 of the cam abutting end 1260 of the link 1232 is shorter than if the link 1232 did not include the radial offset provided by the jog portion 1264.

As will be appreciated, the link 1232 may be configured without the jog portion 1264 such that the cam abutting face 1280 of the cam abutting end 1260 is not radially offset from but instead coincides with the release pin abutting face 1282 of the release pin abutting end 1262. Without the jog portion 1264, a straight or linear link may be provided that is simpler in structure than a link provided with a jog portion. The arc path of the abutting faces of the straight link would then be the same at both ends of the link 1232, that is, the cam abutting face 1280 of the cam abutting end 1260 and the release pin abutting face 1282 of the release pin abutting end 1262 would have the same length arc path. This, of course, would require the cam surface 1230 have a larger height than if the jog portion 1264 were provided.

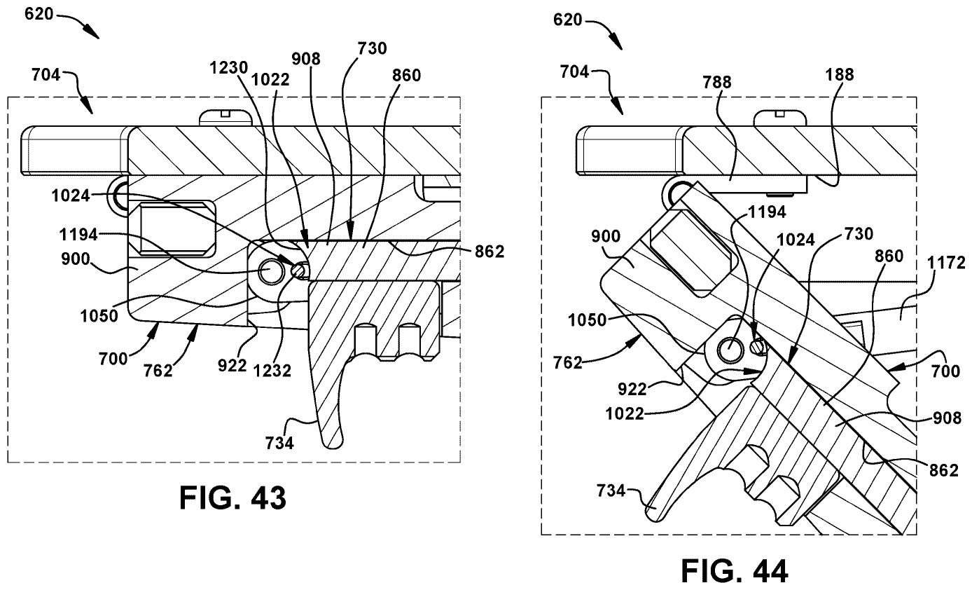

With continued reference to FIGS. 33, 37-40 and 42-44, the cam surface 1230 of the actuating member 1022 of the linearly displaceable bar 732 will now be described in greater detail. The cam surface 1230 is formed integrally with the intermediate elongated member 860 of the linearly displaceable bar 732, for example as a monolithic component, or may be attached to an end of the intermediate elongated member 860 for example as by a threading engagement. The cam surface 1230 has a contour to compensate for the change in angles of the locking gas spring 1026 relative to the frame 700, whether in the locked position for example the change between the angle shown in FIGS. 33 and 43 and the angle shown in FIGS. 42 and 44, or whether in the unlocked position for example the change between the angle shown in FIGS. 37-38 and 40 and the angle shown in FIG. 42 but with the handle 734 pulled back to the upper left in FIG. 42.

The cam surface 1230 has an arc shape that is configured to maintain constant contact with the link 1232 and thus the locking gas spring 1026 regardless of the angular position of the head support plate 720 relative to the frame 700. As shown in FIGS. 33 and 42-44, the cam surface 1230 is configured such that when the head support plate 720 is in the locked position at any angular position of the head support plate 720 relative to the frame 700, the cam surface 1230 is in abutting contact with the cam abutting end 1260 of the link 1232, and the release pin abutting end 1262 of the link 1232, in turn, is in abutting contact with the unpressed release pin 1170 of the locking gas spring 1026, regardless of the angular position. As shown in FIGS. 37-38 and 40, and FIG. 42 but with the handle 734 pulled back to the upper left, the cam surface 1230 is also configured such that when the head support plate 720 is in the unlocked position at any angular position of the head support plate 720 relative to the frame 700, the cam surface 1230 is in abutting contact with the cam abutting end 1260 of the link 1232, and the release pin abutting end 1262 of the link 1232, in turn, is in abutting contact with the pressed release pin 1170 of the locking gas spring 1026, regardless of the angular position.

Thus, for example, in FIGS. 33-34, 39 and 43, where the head support plate 720 is shown not tilted relative to the frame 700, the cam surface 1230 is in abutting contact with the cam abutting face 1280 of the cam abutting end 1260 of the link 1232, and the release pin abutting end 1262 of the link 1232 is in abutting contact with the unpressed release pin 1170 of the locking gas spring 1026, and in FIGS. 42 and 44, where the head support plate 720 is shown tilted approximately 45 degrees relative to the frame 700, the cam surface 1230 also is in abutting contact with the cam abutting face 1280 of the cam abutting end 1260 of the link 1232, and the release pin abutting end 1262 of the link 1232 is in abutting contact with the unpressed release pin 1170 of the locking gas spring 1026. As will be appreciated, with the cam surface 1230 configured in such manner, the cam surface 1230 enables the linearly displaceable bar 732 to pivot the link 1232 about the link pivot axis F-F to press the release pin 1170 of the locking gas spring 1026 at any angular position of the head support plate 720 relative to the frame 700. As such, when the linearly displaceable bar 732 is the locked position, regardless of the angle between the head support plate 720 and the frame 700, the amount the operator must pull the linearly displaceable bar 732 to press the release pin 1170 of the locking gas spring 1026 to thereby unlock the head support plate 720 pivotably relative to the frame 700, remains the same at any angular position of the head support plate 720 relative to the frame 700. In this way, when the linearly displaceable bar 732 is in the locked position, the cam surface 1230 is configured to maintain abutting contact with the link 1232 and the link 1232 in abutting contact with the release pin 1170 at any angular position of the head support plate 720 relative to the frame 700.

By way of further example, in FIGS. 37-38 and 40, where the head support plate 720 is shown not tilted relative to the frame 700, the cam surface 1230 is in abutting contact with the cam abutting face 1280 of the cam abutting end 1260 of the link 1232, and the release pin abutting end 1262 of the link 1232 is in abutting contact with the pressed release pin 1170 of the locking gas spring 1026, and in FIGS. 42 and 44, where the head support plate 720 is shown tilted approximately 45 degrees relative to the frame 700, and assuming the handle 734 is pulled back to the upper left in FIGS. 42 and 44, the cam surface 1230 also is in abutting contact with the cam abutting face 1280 of the cam abutting end 1260 of the link 1232, and the release pin abutting end 1262 of the link 1232 is in abutting contact with the pressed release pin 1170 of the locking gas spring 1026. As will be appreciated, with the cam surface 1230 configured in such manner, the cam surface 1230 enables the link 1232 to remain pivoted about the link pivot axis F-F to maintain the release pin 1170 of the locking gas spring 1026 in a pressed state at any angular position of the head support plate 720 relative to the frame 700. As such, once an operator has moved the linearly displaceable bar 732 from the locked position to the unlocked position to press the release pin 1170 of the locking gas spring 1026 to thereby unlock the head support plate 720 pivotably relative to the frame 700, the head support plate 720 can be pivotably adjusted relative to the frame 700 about the hinged connection pivot axis B-B without the release pin 1170 inadvertently being released and inadvertently locking the locking gas spring 1026. In this way, when the linearly displaceable bar 732 is in the unlocked position, the cam surface 1230 is configured to keep the release pin 1170 pressed and thus the locking gas spring 1026 unlocked throughout the pivotable movement of the head support plate 720 relative to the frame 700 about the hinged connection pivot axis B-B.

Turning now to FIGS. 45-47, and with continued reference to FIGS. 32-44, an example of operation of the adjustable headrest 620 will now be described in greater detail. FIG. 45 shows the adjustable headrest 620 including the frame 700 and head support plate 720 thereof locked in a horizontal position. To adjust the frame 700 and the head support plate 720 pivotably from the position shown in FIG. 46 to the position shown in FIG. 45, the operator pulls on the user handle 734 of the lock-unlock actuator 730 against the spring bias force of the spring 736 from the locked position shown for example in FIGS. 28, 32-36, 39, 41-44 and 48, to the unlocked position shown for example in FIGS. 37-38 and 40, which operates to compress the spring 736, and to disengage the pawl 1000 with respect to the primary arc shape gear 1004 as shown in FIGS. 37-38, and to transfer force from the actuating member 1022 of the linearly displaceable bar 732 to the locking gas spring 1026 via the force transfer member 1024 thereby to unlock the locking gas spring 1026 as shown in FIGS. 38 and 40. The operator may then pivot the frame 700 with respect to the attachment member 22 for example clockwise 45 degrees from FIG. 46 to FIG. 45, and likewise pivot the head support plate 720 with respect to the frame 700 for example counterclockwise 45 degrees from FIG. 46 to FIG. 45. The operator may then release the user handle 734, whereby the spring bias force of the spring 736 will return the lock-unlock actuator 730 from the unlocked position shown for example in FIGS. 37-38 and 40 the locked position shown for example in FIGS. 28, 32-36, 39, 41-44 and 48, thereby locking adjustable headrest 620 in the position shown in FIG. 45. To pivot the adjustable headrest 620 from the FIG. 46 position to the FIG. 47 position, the operator may pull the user handle 734 (in FIG. 46), pivot the frame 700 of the adjustable headrest 620 to the FIG. 47 position, then release the user handle 734 to lock the adjustable headrest 620 in the FIG. 47 position.

Referring to FIGS. 33-35, it can be seen that in the locked position the linearly displaceable bar 732 of the lock-unlock actuator 730 is configured to lock the frame 700 and lock the head support plate 720 simultaneously. Further, referring to FIGS. 33-35 and 37-38, it can be seen that when the lock-unlock actuator 730 is pulled from the locked position shown in FIGS. 33-35 to the unlocked position shown in FIGS. 37-38, the linearly displaceable bar 732 is configured to unlock the frame 700 and unlock the head support plate 720 simultaneously.

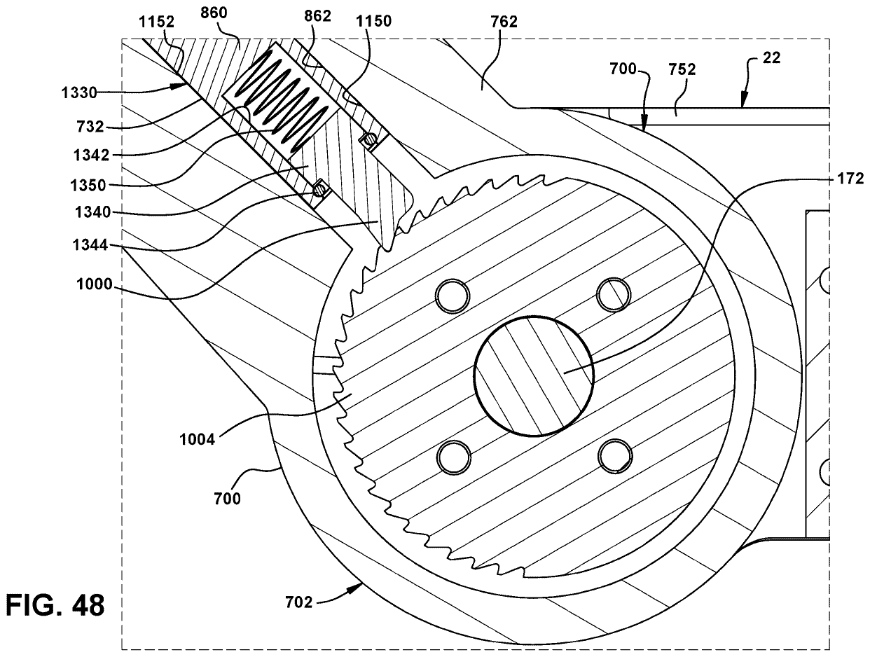

FIG. 48 shows a lock-unlock actuator 1330 in accordance with another embodiment of the invention. The FIG. 48 lock-unlock actuator 1330 is in many respects similar to the above-described lock-unlock actuator 730, and consequently the same reference numerals are used to denote structures corresponding to similar structures in the lock-unlock actuator 730. In addition, the foregoing description of the lock-unlock actuator 730, including the linearly displaceable bar 732, the user handle 734, the spring 736, and the pawl 1000, is equally applicable to the FIG. 48 lock-unlock actuator 1330 except as noted below. Moreover, it will be appreciated upon reading and understanding the specification that aspects of the lock-unlock actuators 730, 1330 may be substituted for one another or used in conjunction with one another where applicable.

Turning then to FIG. 48, the pawl 1000 of the lock-unlock actuator 1330 includes a sliding element 1340 slidably received in a slightly larger size cavity, receptacle, or cylinder 1342 in the end of the intermediate elongated member 860 of the linearly displaceable bar 732. The pawl 1000 may be retained within the cylinder 1342 by a retaining ring 1344. A spring 1350, in the illustrated embodiment a linear compression spring, is provided within the cylinder 1342 to exert a spring bias force against the pawl 1000 in a direction away from a bottom wall of cylinder 1342 in the intermediate elongated member 860 and toward the primary arc shape gear 1004.

The pawl 1000 equipped with the sliding element 1340 enables three different operating conditions that are analogous to the three different operating conditions described in FIGS. 24-26 with respect to the sliding element 540 of the afore described lock-unlock actuator 530. In a first operating condition, analogous to the FIG. 24 operating condition of the afore described lock-unlock actuator 530, the lock-unlock actuator 1330 is in a locked position and the spring 1350 is fully compressed within the cylinder 1342. As such, the pawl 1000 is engaged with respect to the primary arc shape gear 1004 to lock the frame 700 pivotably against lowering of the distal end 704 of the frame 700 relative to the attachment member 22. Also, the release pin 1170 of the locking gas spring 1026 is in an unpressed or released state to lock the locking gas spring 1026 and thereby locking the head support plate 720 pivotably relative to the frame 700. As such, the frame 700 cannot be pivoted relative to the attachment member 22 and the head support plate 720 cannot be pivoted relative to the frame 700.

In a second operating condition, which is shown in FIG. 48 and is analogous to the FIG. 25 operating condition of the afore described lock-unlock actuator 530, the lock-unlock actuator 1330 is in a partially retracted position, that is an intermediate position that is between the locked position and a fully retracted unlocked position, and the spring 1350 is partially compressed within the cylinder 1342, that is, less compressed than in the fully compressed state. As such, the pawl 1000 remains engaged with respect to the primary arc shape gear 1004 to keep the frame 700 locked pivotably against lowering of the distal end 704 of the frame 700 relative to the attachment member 22. However, the release pin 1170 of the locking gas spring 1026 is pressed to unlock the locking gas spring 1026 and thereby unlock the head support plate 720 pivotably relative to the frame 700. As such, although the frame 700 cannot be pivoted relative to the attachment member 22, the head support plate 720 can be pivoted relative to the frame 700. This allows an operator to adjust the head support plate 720 pivotably relative to the frame 700 for example while the frame 700 is locked pivotably against lowering of the distal end 702 of the frame 700 relative to the attachment member 22, or after having pivoted and locked the frame 700 relative to the attachment member 22.

In a third operating condition, analogous to the FIG. 26 operating condition of the afore described lock-unlock actuator 530, the lock-unlock actuator 1330 is in a fully retracted unlocked position, and the spring 1350 is uncompressed. Here the pawl 1000 is disengaged with respect to the primary arc shape gear 1004 to unlock the frame 700 pivotably relative to the attachment member 22 to allow lowering of the distal end 704 of the frame 700 relative to the attachment member 22. Also, the release pin 1170 of the locking gas spring 1026 is pressed to unlock the locking gas spring 1026 and thereby unlock the head support plate 720 pivotably relative to the frame 700. As such, the frame 700 can be pivoted relative to the attachment member 22 and the head support plate 720 can be pivoted relative to the frame 700. This allows an operator both to adjust the head support plate 720 pivotably relative to the frame 700 and to adjust the frame 700 pivotably relative to the attachment member 22, simultaneously if desired.

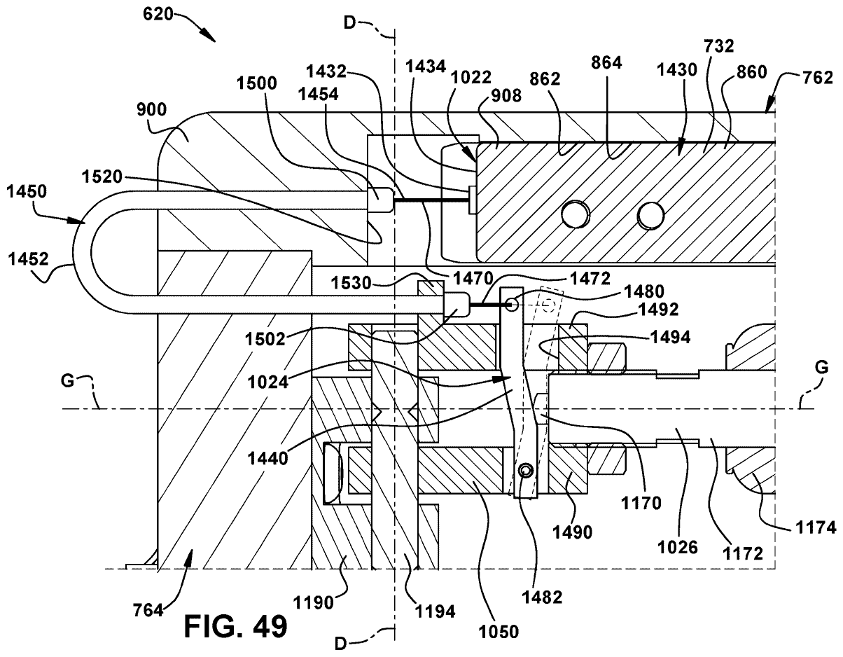

FIG. 49 shows a lock-unlock actuator 1430 in accordance with another embodiment of the invention. The FIG. 49 lock-unlock actuator 1430 is in many respects similar to the above-described lock-unlock actuators 730, 1330, and consequently the same reference numerals are used to denote structures corresponding to similar structures in the lock-unlock actuators 730, 1330. In addition, the foregoing description of the lock-unlock actuators 730, 1330, including the linearly displaceable bar 732, the user handle 734, the spring 736, and the pawl 1000, is equally applicable to the FIG. 49 lock-unlock actuator 1430 except as noted below. Moreover, it will be appreciated upon reading and understanding the specification that aspects of the lock-unlock actuators 730, 1330, 1430 may be substituted for one another or used in conjunction with one another where applicable.

Turning then to FIG. 49, the actuating member 1022 of the lock-unlock actuator 1430 includes a cable mount 1432 on a wall 1434 of the linearly displaceable bar 732, and the force transfer member 1024 includes a link 1440 and a cable mechanism 1450. The cable mechanism 1450 includes a flexible sheath 1452 within which is provided a flexible cable 1454. One end 1470 of the flexible cable 1454 is connected to the cable mount 1432 of the linearly displaceable bar 1432, and an opposite end 1472 of the flexible cable 1454 is coupled to a cable connection end 1480 of the link 1440. The link 1440 includes the cable connection end 1480 at one end thereof, a pivot connection end 1482 at an opposite end thereof, and a pin abutting portion 1484 between the cable connection end 1480 and the pivot connection end 1482. The pivot connection end 1482 is pivotably mounted to a left side clevis arm 1490 of the frame connection end 1050 of the locking gas spring 1026 about a link pivot axis, which like the link pivot axis F-F of the earlier described embodiments is perpendicular to the spring-frame connection pivot axis D-D and perpendicular to the actuation axis G-G of the locking gas spring 1026. A right side clevis arm 1492 of the frame connection end 1050 of the locking gas spring 1026 has an opening 1494 therein within which the cable connection end 1480 moves as the link 1440 pivots about the link pivot axis. The flexible sheath 1452 of the cable mechanism 1450 is connected at one end 1500 to an upright wall 1520 oppositely facing the wall 1434 of the linearly displaceable bar 732 and at an opposite end 1502 to a projection 1522 projecting rightward from the side of the right side clevis arm 1492 of the frame connection end 1050. The flexible sheath 1452 and the flexible cable 1454 are configured to flex as the head support plate 720 is pivotably moved relative to the frame 700 about the hinged connection pivot axis B-B and the frame connection end 1050 is pivotably moved about the spring-frame connection joint 1194 about the spring-frame connection pivot axis D-D. The flexible sheath 1452 and the flexible cable 1454 enable the cable forces at the opposite ends 1470, 1472 thereof to be in line respectively with the direction of linear displacement of the linearly displaceable bar 732 and the actuation axis G-G of the locking gas spring 1026.

The lock-unlock actuator 1430 operates in an analogous manner to that of the lock-unlock actuators 730, 1330. In the locked position the linearly displaceable bar 732 is configured to reduce the force from the actuating member 1022 on the force transfer member 1024 to lock the locking gas spring 1026, thereby to lock the head support plate 720 pivotably relative to the frame 700. Thus, in the locked position, the wall 1434 of the linearly displaceable bar 732 and the cable connection end 1480 of the link 1440 are positioned as shown in FIG. 49, with the intermediate pin abutting portion 1484 abutting the release pin 1170 of the locking gas spring 1026. In the unlocked position, the linearly displaceable bar 732 is configured to increase the force from the actuating member 1022 on the force transfer member 1024 to unlock the locking gas spring 1026, thereby to unlock the head support plate 720 pivotably relative to the frame 700. Thus, in the unlocked position, the cable mount 1432 and the wall 1434 of the linearly displaceable bar 732, in response the operator pulling on the handle 734, move to the left in FIG. 49, or in a frame proximal end 702 to frame distal end 704 direction, which causes the flexible cable 1454 to move the cable connection end 1480 of the link 1440 to the right in FIG. 49, which causes the intermediate pin abutting portion 1484 to press the release pin 1170 of the locking gas spring 1026, as shown by the dashed lines link in FIG. 49. The frame connection end 1050 is thus pivotably movable about the spring-frame connection pivot axis D-D and, consequently, the head support plate 720 is pivotably movable relative to the frame 700 about the hinged connection pivot axis B-B.

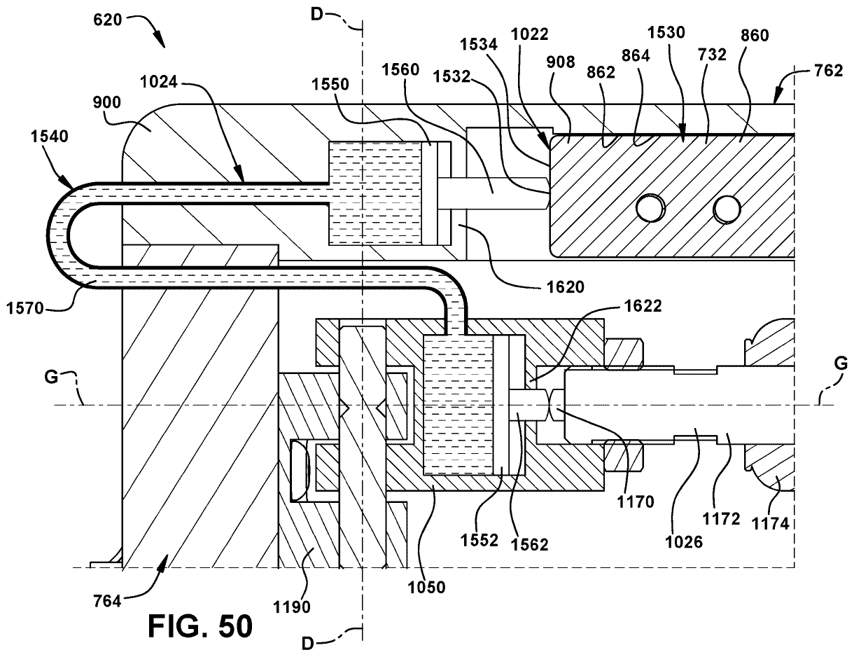

FIG. 50 shows a lock-unlock actuator 1530 in accordance with another embodiment of the invention. The FIG. 50 lock-unlock actuator 1530 is in many respects similar to the above-described lock-unlock actuators 730, 1330, 1430, and consequently the same reference numerals are used to denote structures corresponding to similar structures in the lock-unlock actuators 730, 1330, 1430. In addition, the foregoing description of the lock-unlock actuators 730, 1330, 1430, including the linearly displaceable bar 732, the user handle 734, the spring 736, and the pawl 1000, is equally applicable to the FIG. 50 lock-unlock actuator 1530 except as noted below. Moreover, it will be appreciated upon reading and understanding the specification that aspects of the lock-unlock actuators 730, 1330, 1430, 1530 may be substituted for one another or used in conjunction with one another where applicable.

Turning then to FIG. 50, the actuating member 1022 of the lock-unlock actuator 1530 includes a piston rod abutting surface 1532 on a wall 1534 of the linearly displaceable bar 732, and the force transfer member 1024 includes a hydraulic machine 1540 configured to transfer force from the piston rod abutting surface 1532 of the linearly displaceable bar 732 to the release pin 1170 of the locking gas spring 1026. As shown in FIG. 50, the hydraulic machine 1540 includes first and second pistons 1550, 1552 having respective first and second piston rods 1560, 1562 projecting therefrom, and a flexible tubing 1570 that is configured to transfer pressure from the first piston 1550 to the second piston 1552, and vice versa. The first piston 1550 may be housed in the right side frame member 762 of the frame 700 and the second piston 1552 may be housed in the frame connection end 1050 of the locking gas spring 1026. The first piston rod 1560 projects through an upright wall 1620 oppositely facing the wall 1534 of the linearly displaceable bar 732 and abuts the piston rod abutting surface 1532 of the linearly displaceable bar 732. The second piston rod 1562 projects through an upright wall 1622 oppositely facing the release pin 1170 of the locking gas spring 1026 and abuts the release pin 1170. The flexible tubing 1570 is configured to flex as the head support plate 720 is pivotably moved relative to the frame 700 about the hinged connection pivot axis B-B and the frame connection end 1050 is pivotably moved about the spring-frame connection joint 1194 about the spring-frame connection pivot axis D-D. The flexible tubing 1470 enables the opposite end hydraulic forces of the piston rods 1560, 1562 to be in line respectively with the direction of linear displacement of the linearly displaceable bar 732 and the actuation axis G-G of the locking gas spring 1026.

The lock-unlock actuator 1530 operates in an analogous manner to that of the lock-unlock actuators 730, 1330, 1430. In the locked position the linearly displaceable bar 732 is configured to reduce the force from the actuating member 1022 on the force transfer member 1024 to lock the locking gas spring 1026, thereby to lock the head support plate 720 pivotably relative to the frame 700. Thus, in the locked position, the piston rod abutting surface 1532 of the wall 1434 of the linearly displaceable bar 732 and the first piston rod 1560 of the first piston 1550 are positioned as shown in FIG. 50, with the second piston rod 1562 of the second piston 1552 abutting the release pin 1170 of the locking gas spring 1026. In the unlocked position, the linearly displaceable bar 732 is configured to increase the force from the actuating member 1022 on the force transfer member 1024 to unlock the locking gas spring 1026, thereby to unlock the head support plate 720 pivotably relative to the frame 700. Thus, in the unlocked position, the first piston rod 1560 of the hydraulic machine 1540 and the wall 1534 of the linearly displaceable bar 732, in response the operator pulling on the handle 734, move to the left in FIG. 50, or in a frame proximal end 702 to frame distal end 704 direction, which causes the hydraulic fluid in the flexible tubing 1570 of the hydraulic machine 1540 to move the second piston 1552 to the right in FIG. 50, which causes the second piston rod 1562 to press the release pin 1170 of the locking gas spring 1026. The frame connection end 1050 is thus pivotably movable about the spring-frame connection pivot axis D-D and, consequently, the head support plate 720 is pivotably movable relative to the frame 700 about the hinged connection pivot axis B-B.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. An adjustable headrest for a surgical table, comprising:
an attachment member configured to be releasably mounted to the surgical table;
a frame having a proximal end and a distal end, the proximal end being mounted for pivotable movement relative to the attachment member to raise and lower the distal end relative to the attachment member;
a head support plate mounted for pivotable movement relative to the frame to tilt the head support plate relative to the frame;
a lock-unlock actuator including a linearly displaceable bar and a user handle, the linearly displaceable bar being supported and slidably guided by the frame for translating movement between a first position and a second position and being spring biased to move from the second position to the first position, the user handle being configured to move the linearly displaceable bar against the spring bias force from the first position to the second position;
wherein in the first position the linearly displaceable bar is configured to lock the frame pivotably against lowering of the distal end of the frame relative to the attachment member and to lock the head support plate pivotably relative to the frame, and wherein in the second position the linearly displaceable bar is configured to unlock the frame pivotably relative to the attachment member to allow lowering of the distal end of the frame relative to the attachment member and to unlock the head support plate pivotably relative to the frame.

2. The adjustable headrest of claim 1, wherein in the first position the linearly displaceable bar is configured to lock the frame and lock the head support plate simultaneously.

3. The adjustable headrest of claim 1, wherein in the second position the linearly displaceable bar is configured to unlock the frame and unlock the head support plate simultaneously.

4. The adjustable headrest of claim 1, wherein in the first position the linearly displaceable bar is configured to lock the frame pivotably against raising of the distal end of the frame relative to the attachment member.

5. The adjustable headrest of claim 1, wherein the attachment member includes a primary arc shape gear and the lock-unlock actuator includes a primary mating gear, wherein in the first position the linearly displaceable bar is configured to engage the primary mating gear with respect to the primary arc shape gear to lock the frame pivotably against lowering of the distal end of the frame relative to the attachment member, and
wherein in the second position the linearly displaceable bar is configured to disengage the primary mating gear with respect to the primary arc shape gear to unlock the frame pivotably relative to the attachment member to allow lowering of the distal end of the frame relative to the attachment member.

6. (canceled)

7. The adjustable headrest of claim 1, wherein the lock-unlock actuator includes a secondary mating gear and the head support plate includes a secondary arc shape gear, wherein in the first position the linearly displaceable bar is configured to engage the secondary mating gear with respect to the secondary arc shape gear to lock the head support plate pivotably relative to the frame, and
wherein in the second position the linearly displaceable bar is configured to disengage the secondary mating gear with respect to the secondary arc shape gear to unlock the head support plate pivotably relative to the frame.

8. (canceled)

9. The adjustable headrest of claim 1, wherein the attachment member includes a primary arc shape gear and the lock-unlock actuator includes a pawl, wherein the pawl and the primary arc shape gear form a ratchet and pawl mechanism that allows pivotable movement in one direction while preventing pivotable movement in an opposite direction.

10. The adjustable headrest of claim 9, wherein in the first position the linearly displaceable bar is configured to engage the pawl with respect to the primary arc shape gear to lock the frame pivotably against lowering of the distal end of the frame relative to the attachment member, and
wherein in the first position the linearly displaceable bar does not lock the frame pivotably against raising of the distal end of the frame relative to the attachment member.

11. (canceled)

12. The adjustable headrest of claim 9, wherein in the first position, in response to raising of the distal end of the frame relative to the attachment member, the primary arc shape gear is configured to move the linearly displaceable bar against the spring bias force of the spring from the first position to an intermediate ratchet release position in which the pawl is retracted from engagement with respect to the primary arc shape gear.

13. The adjustable headrest of claim 9, wherein in the second position the linearly displaceable bar is configured to disengage the pawl with respect to the primary arc shape gear to unlock the frame pivotably relative to the attachment member to allow lowering of the distal end of the frame relative to the attachment member.

14. The adjustable headrest of claim 1, further comprising a locking gas spring having a frame connection end at one end thereof and a plate connection end at an opposite end thereof, the locking gas spring being pivotably mounted at the frame connection end to the frame and pivotably mounted at the plate connection end to the head support plate.

15. The adjustable headrest of claim 14, wherein the linearly displaceable bar includes an actuating member and the lock-unlock actuator includes a force transfer member configured to transfer force from the actuating member to the locking gas spring to selectively lock and unlock the locking gas spring.

16. The adjustable headrest of claim 15, wherein in the first position the linearly displaceable bar is configured to reduce the force from the actuating member on the force transfer member to lock the locking gas spring, thereby to lock the head support plate pivotably relative to the frame.

17. The adjustable headrest of claim 15, wherein in the second position the linearly displaceable bar is configured to increase the force from the actuating member on the force transfer member to unlock the locking gas spring, thereby to unlock the head support plate pivotably relative to the frame.

18. The adjustable headrest of claim 15, wherein the actuating member includes a cam surface of the linearly displaceable bar and the force transfer member includes a link configured to transfer force from the cam surface to a release pin of the locking gas spring.

19. The adjustable headrest of claim 18, wherein the locking gas spring is pivotably mounted to the frame about a spring-frame connection pivot axis, and
wherein the link is pivotably mounted to the frame connection end of the locking gas spring about a link pivot axis that is perpendicular to the spring-frame connection pivot axis and perpendicular to an actuation axis of the locking gas spring.

20. (canceled)

21. The adjustable headrest of claim 18, wherein the link includes a cam abutting end that abuts the cam surface and a release pin abutting end that abuts the release pin, and a jog portion between the cam abutting end and the release pin abutting end that radially offsets a central axis of the cam abutting end from a central axis of the release pin abutting end.

22. The adjustable headrest of claim 15, wherein the actuating member includes a cable connection on the linearly displaceable bar, and the force transfer member includes a link and a cable mechanism coupled to the link, wherein the cable mechanism is configured to transfer force from the cable connection to the link, and the link is configured to transfer force from the link to a release pin of the locking gas spring.

23. The adjustable headrest of claim 15, wherein the actuating member includes a piston coupler on the linearly displaceable bar, and the force transfer member includes a hydraulic machine configured to transfer force from the piston coupler to a release pin of the locking gas spring.

24. (canceled)

25. (canceled)

26. The adjustable headrest of claim 1, wherein the head support plate includes a pair of rails depending from an underside of the head support plate, the pair of rails defining therebetween a rectangular imaging volume under the head support plate for slidably receiving an X-ray board, wherein the linearly displaceable bar is outside of the pair of rails and outside of the rectangular imaging volume.
